(19) United States
(12) Patent Application Publication
(10) Pub. No.: US 2014/0012426 A1
(43) Pub. Date: Jan. 9, 2014

(54) POWER LEVELING CONTROLLER, POWER LEVELING STORAGE BATTERY, AND METHOD

(71) Applicant: Fujitsu Limited, Kawasaki (JP)

(72) Inventor: Toshiaki FUNAKUBO, Kawasaki (JP)

(73) Assignee: Fujitsu Limited, Kawasaki (JP)

(21) Appl. No.: 14/023,879

(22) Filed: Sep. 11, 2013

Related U.S. Application Data
(63) Continuation of application No. PCT/JP2011/056665, filed on Mar. 18, 2011.

(51) Int. Cl. H02J 1/14

(52) U.S. Cl. CPC H02J 1/14
USPC 700/286

(57) ABSTRACT

A switch unit is controlled by a power leveling controller so as to cut off a connection between the power source, and the storage battery and the load when cumulative electric energy exceeds a leveling target value, and to connect the connection when a unit of time has passed. At that time, a processor of the power leveling controller determines to increase, decrease, or maintain a current leveling target value for the leveling target value to be used in a next cycle for power leveling at an end of a leveling cycle according to a value representing a transition in a record of the transition of the remaining battery power of the storage battery in the leveling cycle. Accordingly, it becomes possible to effectively utilize the capacity of a storage battery, and to perform power leveling with a simple process where demand forecasting is not required.

### CROSS-REFERENCE TO RELATED APPLICATIONS

This application is a continuation application of International Application PCT/JP2011/56665 filed on Mar. 18, 2011 and designated the U.S., the entire contents of which are incorporated herein by reference.

### FIELD

The embodiments discussed herein are related to a power leveling controller, power leveling storage battery, and a method for controlling power leveling.

### BACKGROUND

The demand for electricity varies due to various factors. Factors responsible for major variations include the day of the week, the season, the staff present at offices, a plant layout, or the like. It may be small, but the demand for electricity also changes due to the daily behavior of a user. For this reason, normally, electric power facilities are designed to be prepared for demand peaks such that there will be no shortage of electricity when the demand for electricity reaches a peak.

However, there have been attempts to lower the peaks of the demand for electricity in view of environmental problems or cost problems, by performing leveling where a storage battery is used to meet the demand with the stored electricity when the demand is high and power is stored in the storage battery when the demand is low. If it becomes possible to reduce the demand peak as above and to level out the fluctuating demand, it will become possible to reduce the amount of carbon dioxide (CO₂) emissions and to achieve cost reduction by, for example, increasing the ratio of nuclear electric power generation, which is designed to avoid output fluctuations as much as possible, in meeting the demand.

In the leveling control where a storage battery is used, it is a possible configuration for a desired output value to be set and for the excess to be charged to the storage battery when the output from the power source is greater than the desired output value, and for the shortage to be covered by the discharge from the storage battery when the output is smaller than the desired output value. There is an example in such a configuration in which the output from the power source and the amount of the power stored in the storage battery are detected, and an average value of the output over a specified period is adjusted by a target value set according to the amount of the stored power, thereby setting a desired output value. There is an example in which an average value of the power consumption since the start of a demand interval is calculated according to power consumption information and the storage battery is discharged when the average value exceeds the first specified value, and the storage battery is charged when the average value is below the second specified value. There is an example in which a discharge mode is controlled by detecting an outside air temperature, load power, or the like, so as to calculate a prediction value for a demand for electricity, and by comparing the prediction value with a set value. There is also an example in which the past patterns of the remaining battery power of a storage battery are manually set, and a desired output value is set according to the set patterns. There is an example in which power is controlled according to the time variation data of an amount of load power, which has been stored in advance, corresponding to the data of the predicted reference temperature.
Patent Document 1: Japanese Laid-open Patent Publication No. 2002-017044
Patent Document 2: Japanese Laid-open Patent Publication No. 2003-299247
Patent Document 3: Japanese Laid-open Patent Publication No. 2003-244840
Patent Document 4: Japanese Laid-open Patent Publication No. 08-287958
Patent Document 5: Japanese Laid-open Patent Publication No. 2001-008385
Patent Document 6: Japanese Laid-open Patent Publication No. 2005-218193

### SUMMARY

In order to solve the above problems, a power leveling controller in one aspect of the invention levels out power supplied from a power source in a system in which the power source is connected to a storage battery and a load. A remaining battery power obtaining unit obtains an amount of remaining battery power of the storage battery for every monitoring period. A battery power storage unit stores the amount of remaining battery power obtained by the remaining battery power obtaining unit. A target determination unit determines to increase, decrease, or maintain a current leveling target value for the leveling target value to be used in a next cycle for power leveling according to a value representing a transition of the amount of remaining battery power in a cycle in the amount of remaining battery power stored by the battery power storage unit at an end of the cycle where a period in which demand for electricity of the load is high and a period in which demand for electricity of the load is low are predicted to occur in alternate order. A controller controls power that is supplied from the power source and the storage battery to the load according to the leveling target value to be used in the next cycle for power leveling, which is determined by the target determination unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a power leveling system according to the first embodiment.

FIG. 2 is a schematic diagram illustrating the power leveling control according to the first embodiment.

FIG. 3 illustrates an example of the power leveling control according to the first embodiment.

FIG. 4 illustrates an example of the power leveling control in a leveling cycle according to the first embodiment.

FIG. 5 illustrates the definition of an allowable lower limit of the remaining battery power in the power leveling control according to the first embodiment.

FIG. 6 illustrates the definition of the lower use limit for the remaining battery power in the leveling control according to the first embodiment.

FIG. 7 illustrates an example of the determination of excess and deficiency of the remaining battery power when the lower use limit for remaining battery power is set in the power leveling control according to the first embodiment.

FIG. 8 illustrates the determination of the upper use limit for remaining battery power in the power leveling control according to the first embodiment.

FIG. 9 is a flowchart illustrating the operation of the power leveling system according to the first embodiment.

FIG. 10 is a flowchart illustrating the operation of the power leveling system according to the first embodiment.

FIG. 11 is a flowchart illustrating the operation of the power leveling system according to the first embodiment.

FIG. 12 illustrates an example of the result of the leveling control according to the first embodiment.

FIG. 13 illustrates an example of the result of the leveling control according to the first embodiment.

FIG. 14 illustrates an example of the result of the leveling control according to the first embodiment.

FIG. 15 illustrates an example of the result of the leveling control according to the first embodiment.

FIG. 16 illustrates an example of the result of the leveling control according to the first embodiment.

FIG. 17A is a flowchart illustrating how a leveling target value is determined in the modification 1 of the first embodiment in which one condition is adopted as an increasing condition.

FIG. 17B is a flowchart illustrating how a leveling target value is determined in the modification 1 of the first embodiment in which two conditions are adopted as an increasing condition.

FIG. 17C is a flowchart illustrating how a leveling target value is determined in the modification 1 of the first embodiment in which three conditions are adopted as an increasing condition.

FIG. 17D is a flowchart illustrating how a leveling target value is determined in the modification 1 of the first embodiment in which four conditions are adopted as an increasing condition.

FIG. 18A is a flowchart illustrating how a leveling target value is determined in the modification 1 of the first embodiment in which one condition is adopted as a decreasing condition.

FIG. 18B is a flowchart illustrating how a leveling target value is determined in the modification 1 of the first embodiment in which two conditions are adopted as a decreasing condition.

FIG. 18C is a flowchart illustrating how a leveling target value is determined in the modification 1 of the first embodiment in which three conditions are adopted as a decreasing condition.

FIG. 18D is a flowchart illustrating how a leveling target value is determined in the modification 1 of the first embodiment in which four conditions are adopted as a decreasing condition.

FIG. 19 is a flowchart illustrating how a leveling target value is determined in the modification 2 of the first embodiment.

FIG. 20 illustrates a power leveling system according to the second embodiment.

FIG. 21 illustrates an influence caused by the existence of discharging in the power leveling control according to the second embodiment.

FIG. 22A illustrates an influence caused by the operating conditions of the fluctuating load in the power leveling control according to the second embodiment in the first leveling cycle.

FIG. 22B illustrates an influence caused by the operating conditions of the fluctuating load in the power leveling control according to the second embodiment in the second leveling cycle.

FIG. 23A illustrates an influence caused by the operating conditions of the fluctuating load in the power leveling control according to the second embodiment in which the leveling target value is decreased.

FIG. 23B illustrates an influence caused by the operating conditions of the fluctuating load in the power leveling control according to the second embodiment in which the leveling target value is maintained.

FIG. 24 is a flowchart depicting the operations of the power leveling system according to the second embodiment.

FIG. 25 is a flowchart depicting the operations of the power leveling system according to the second embodiment.

FIG. 26 is a flowchart depicting the operations of the power leveling system according to the second embodiment.

FIG. 27 is a flowchart depicting the operations of the power leveling system according to the second embodiment.

FIG. 28 is a block diagram of an example of the hardware configuration of a standard computer.

### DESCRIPTION OF EMBODIMENTS

How a target value is determined is important in the power leveling control as described above. However, it cannot be said that a technique in which an average value is used such as a technique in which a target value for the output power is compared with a value based on an average value for the power supply over a fixed period is a control where the characteristics of a demand for electricity in which fluctuation repeatedly occurs due to the change in a season or time are well considered.

On the other hand, it is troublesome to manually set a target value or a pattern to set a target value. In an example where demand forecasting is performed, some sort of a prediction algorithm is required to perform forecasting, and forecasting is not always credible. The implementation of a high-precision demand forecasting algorithm requires high data-handling capacity, and leveling performance greatly depends on the precision of the demand forecasting because control is performed by using an optimal target value for the demand forecasting. Further, the characteristics of actual devices such as loss of battery power or loss caused at a charge and discharge circuit and charging characteristics need to be accurately modeled in order to search for an optimal target value. However, such modeling requires acquisition of characteristics and a change in the model of an actual device inside a simulator for every model of a storage battery or the like. This causes a problem wherein the number of man-hours for adjustment tends to be enormous.

Preferred embodiments of the present invention will be explained with reference to accompanying drawings.

### First Embodiment

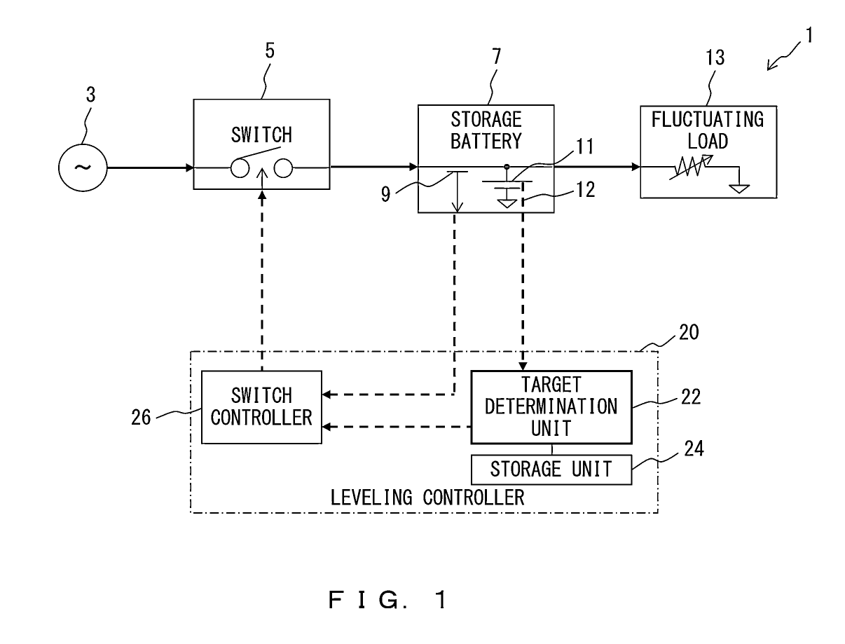

The first embodiment will be described with reference to the accompanying drawings. Firstly, the configuration of a power leveling system 1 according to the first embodiment and an outline of the power leveling control will be described with reference to FIGS. 1-3. FIG. 1 illustrates the power leveling system 1 according to the first embodiment. The power leveling system 1 has a power source 3 to which a storage battery 7 and a fluctuating load 13 are connected through a switch 5, and includes a leveling controller 20 for controlling the operation of the switch 5.

The power source 3 is a commercial power supply. The switch 5 is connected between the power source 3 and the storage battery 7 and the fluctuating load 13 so as to enable switching therebetween. The switch 5 is controlled by the leveling controller 20 to switch the connection, thereby switching the connection between the power source 3 and the storage battery 7 and the fluctuating load 13. The storage battery 7 is connected to the switch 5 and the fluctuating load 13, and includes a received power measurement unit 9, a battery 11, and a remaining battery power level measurement unit 12. The received power measurement unit 9 measures the power received from the power source 3, and outputs a result of the measurement to the leveling controller 20. The battery 11 supplies power to the fluctuating load 13 while charging a part of the power received from the power source 3 according to the opening and closing of the switch 5, or supplies power to the fluctuating load 13 by discharging. The remaining battery power level measurement unit 12 measures the remaining battery power of the battery 11, and outputs a result of the measurement to the leveling controller 20. The fluctuating load 13 is a load to which power is supplied, such as an ordinary household or company, where the level of power consumption fluctuates. Note that when the output of the power source 3, the input and output of the battery 11, and the input of the fluctuating load 13 in FIG. 1 differ in use between alternating current power and direct current power, an alternating current/direct current converter is disposed as necessary.

The leveling controller 20 includes a target determination unit 22, a storage unit 24, and a switch controller 26. The target determination unit 22 determines a leveling target value according to the remaining battery power stored in a storage unit 24, which will be described later, and outputs a result of the determination to the switch controller 26. Moreover, the target determination unit 22 stores the remaining battery power and the determined leveling target value in the storage unit 24. Further, the target determination unit 22 includes a leveling cycle timer (not illustrated), a demand interval timer, and a monitoring control cycle timer, and the target determination unit 22 manages each cycle. How a leveling target value is determined will be described later in detail.

The storage unit 24 is, for example, a Random Access Memory (RAM) or the like. The storage unit 24 stores a program to control the operation of the leveling controller 20, the remaining battery power input from the storage battery 7, the determined leveling target value, or the like. The switch controller 26 outputs an actuating signal to switch the connection status of the switch 5 according to a leveling target value determined by the target determination unit 22 and a received power input from the storage battery 7, and the remaining battery power, thereby controlling the switch 5.

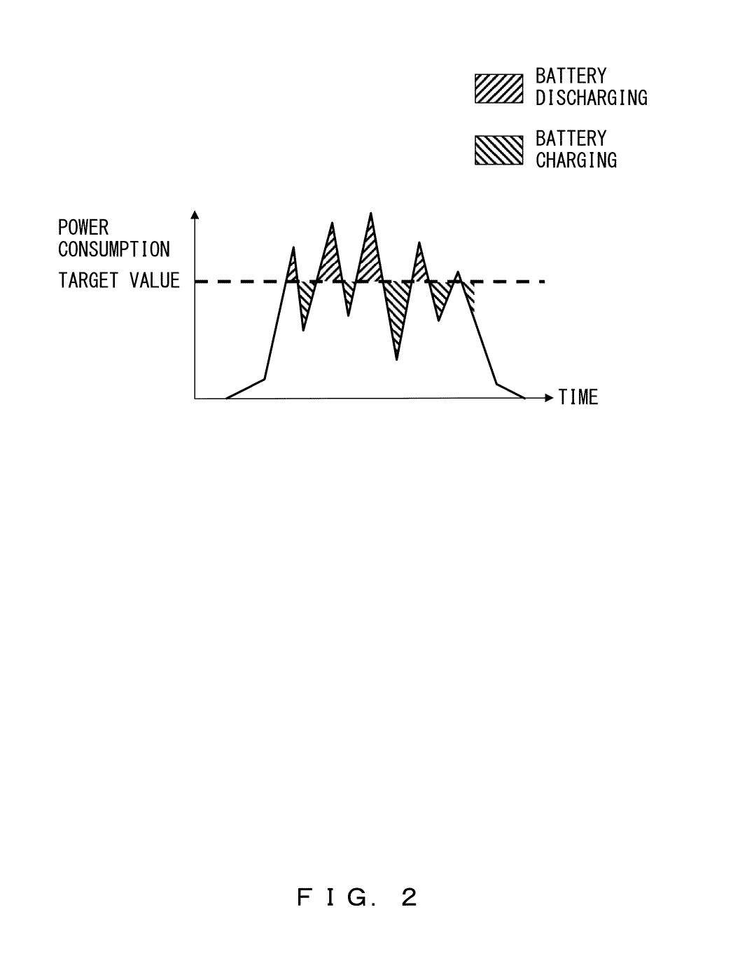

FIG. 2 is a schematic diagram illustrating the power leveling control, where the vertical axis and horizontal axis represent power consumption and a time, respectively. As illustrated in FIG. 2, the battery 11 is charged when the power consumption is below a target value, and the switch 5 is released to supply power from the battery 11 to the fluctuating load 13 when the power consumption is higher than a target value. Note that the power consumption and target value may be electric energy for every unit of time.

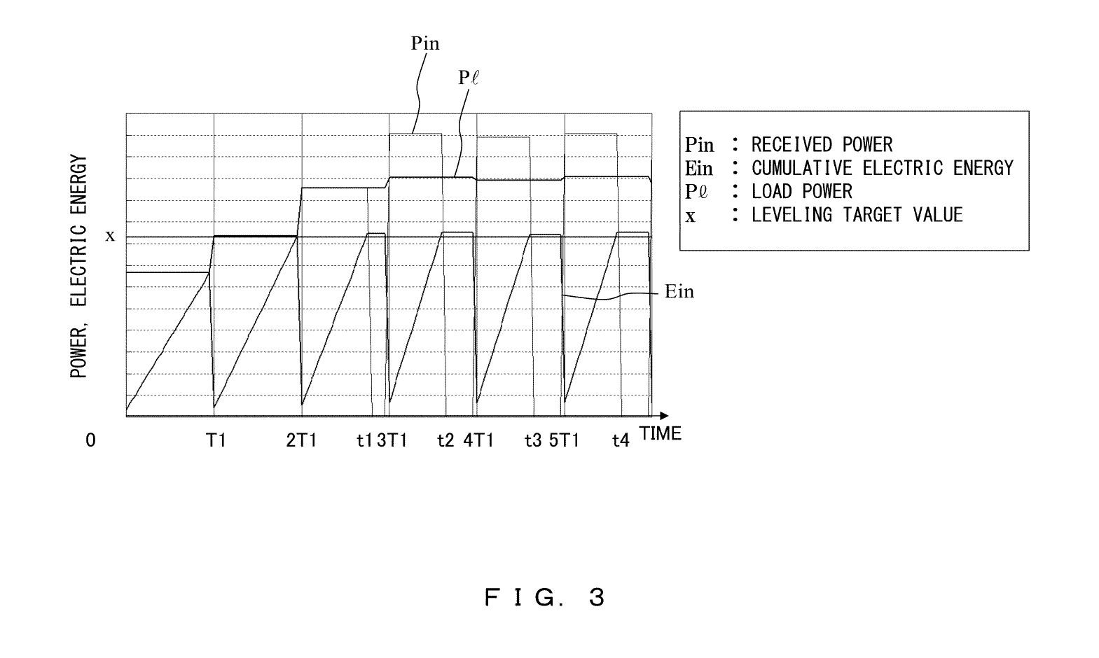

FIG. 3 illustrates an example of the power leveling control, where the vertical axis and horizontal axis represent power and electric energy, and a time, respectively. In the power leveling control, for example, the total electric energy received from the commercial power supply within a specified demand interval is calculated, and the power reception from the power source is controlled according to a comparison between the calculated received electric energy and a leveling target value. In the present embodiment, the received power measurement unit 9 calculates the sum of power consumption at the fluctuating load 13 and the charged energy in the battery 11 as the received power Pin from the power source 3. Accordingly, an example in which the switch 5 is switched in accordance with whether or not cumulative electric energy Ein obtained by accumulating the received power Pin from the power source 3 exceeds a leveling target value at some point in a demand interval T1 will be described with reference to FIG. 3. FIG. 3 illustrates a time variation of the received power Pin, the cumulative electric energy Ein, and load power Pl. The received power Pin indicates the power measured by the received power measurement unit 9. Assuming that the received power Pin measured by the received power measurement unit 9 continues during a monitoring period, the cumulative electric energy Ein indicates the electric energy accumulated during a period in a demand interval. The load power Pl indicates the power consumption at the fluctuating load 13.

As illustrated in FIG. 3, when the power consumption at the fluctuating load 13 changes like the load power Pl, the received power Pin becomes equal to the load power Pl at some time in time “t=0−t1” at which the cumulative electric energy Ein reaches a leveling target value x, where it is assumed that the battery is fully charged at that time. The cumulative electric energy Ein represents the electric energy accumulated in the demand interval T1, and draws a track like a saw wave over time “t=0−2T1” where the cumulative electric energy Ein does not reach the leveling target value x and the load power is constant. In the example of FIG. 3, the load power Pl rises near time t=2T1. As the load power Pl rises, the received power Pin also rises. Accordingly, the cumulative electric energy Ein exceeds the leveling target value x at time t=t1, and the switch 5 is released and the battery 11 starts discharging. While the switch 5 is being released, the received power Pin=0. The battery 11 discharges over time “t=t1−3T1”.

When the period enters the next demand interval at time “t=3T1”, the cumulative electric energy Ein is reset. Accordingly, the switch 5 is closed again, and the power reception from the power source 3 starts. As a result, power is received over time “t=3T−t2”. The cumulative electric energy Ein exceeds the leveling target value x again at time t=t2, and the switch 5 is released and the battery 11 starts discharging. Similar operations will be repeated afterward. In the present example, the battery 11 is charged after time “t=3T1” at which the battery 11 is discharged. For this reason, the received power Pin is equal to the power obtained by combining the load power Pl and the power charged in the battery 11. By so doing, power leveling control is performed in which the received electric energy Ein in a demand interval is limited to a value equivalent to the leveling target value x.

How a leveling target value is determined in the power leveling system 1 according to the first embodiment, which is configured as above, will be described. In power leveling control as described above, a leveling cycle is determined, and feedback control is performed so as to update a leveling target value in the future according to the leveling cycle in the past. As the fluctuating load 13 normally fluctuates in accordance with the activity condition of people, for example, it is usually the case that a period in which demand for electricity is high and a period in which demand for electricity is low come alternately in a cycle of one day. For this reason, in the present embodiment, a cycle in which a period in which demand for electricity of the fluctuating load 13 is high and a period in which demand for electricity of the fluctuating load 13 is low are predicted to come alternately, e.g., one day (twenty-four hours) in which a daytime demand is high and a night time demand is low, is set to a leveling cycle T0. In another example of the T0, one year in which a summertime demand is high and a winter time demand is low may be set. It is preferred in the power leveling system 1 that the battery 11 be charged to an upper limit of storage capacity in the leveling cycle T0, the power accumulated in the leveling cycle be used up to a lower limit, and that the power accumulated in the leveling cycle be equivalent to the remaining battery power at an early stage of the leveling cycle when the leveling cycle comes to an end.

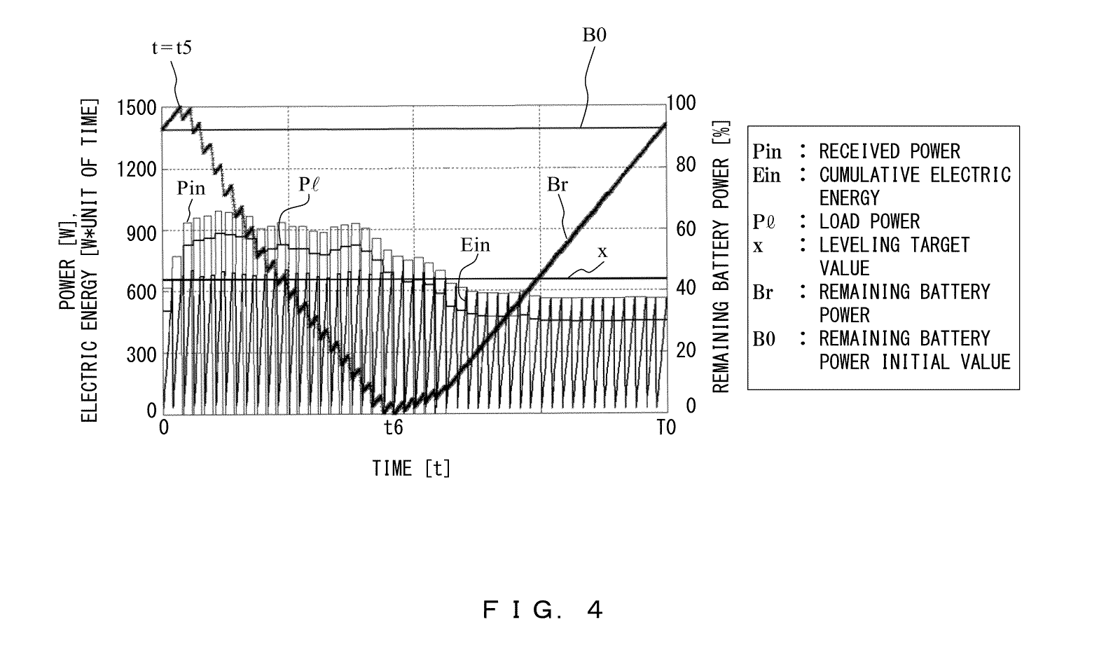

FIG. 4 illustrates an example of the power leveling control in a leveling cycle. In FIG. 4, the horizontal axis represents time, and the vertical axis represents the power, the electric energy, and the remaining battery power. FIG. 4 illustrates an example of the changes in the received power Pin, the cumulative electric energy Ein, the load power Pl, and the remaining battery power Br in the leveling cycle T0, and the leveling target value x, and the remaining battery power initial value B0. As illustrated in FIG. 4, a remaining battery power Br has the remaining battery power initial value B0 at the start time “t=0” of the leveling cycle T0. As the power leveling control is performed in the power leveling system 1, the remaining battery power Br reaches its peak at time “t=t5”, and becomes the lowest at time “t=t6”. Then, the remaining battery power Br becomes equal to the remaining battery power initial value B0 again at the end time “t=T0” of the leveling cycle T0. The leveling target value x with the operation result as above is an ideal value with which the storage capacity is effectively utilized and the peak of the received electric energy in a demand interval is most effectively reduced.

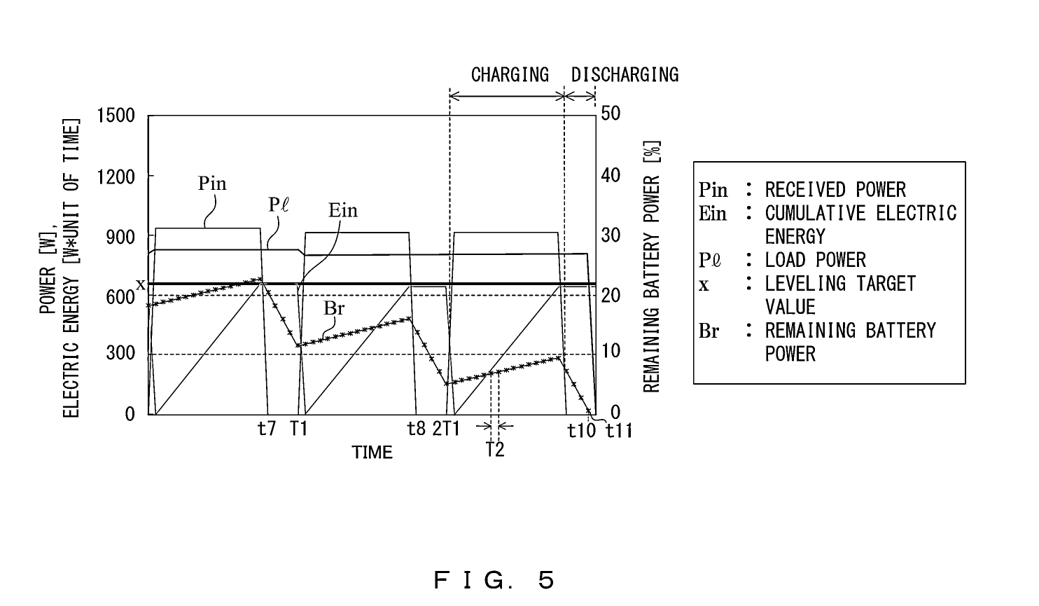

Next, an allowable lower limit of the remaining battery power Br will be described with reference to FIG. 5. FIG. 5 illustrates the definition of an allowable lower limit of the remaining battery power, and also illustrates an example of the state in which the remaining battery power Br becomes zero and the discharge is disabled. In FIG. 5, the horizontal axis represents time, and the vertical axis represents power, electric energy, and the remaining battery power, where an example of the changes in the received power Pin, the cumulative electric energy Ein, the load power Pl, and the remaining battery power Br, and the leveling target value x are illustrated. As illustrated in FIG. 5, the remaining battery power Br is measured by the remaining battery power level measurement unit 12 for every supervisory control period T2. Over time “t=0−t7”, the battery 11 is charged, and thus the remaining battery power Br increases. Over time “t=t7−T1”, the battery 11 is discharged, and thus the remaining battery power Br decreases.

As illustrated in FIG. 5, when the amount of the discharged power is greater than the remaining battery power Br accumulated by charging after charging and discharging are repeated for example, even if the remaining battery power Br≠0 at monitor time “t=t10” where discharging is being performed, there is a possible situation in which the remaining battery power Br=0 at time “t=t11” before the next monitor time. In other words, the supervisory control period T2 is limited, and thus even if the existence of the remaining battery power Br is recognized at a certain monitor time, all the remaining amount may be used up by the next monitor time and the power supply to the fluctuating load 13 may terminate, thereby terminating the load. For this reason, it is desired that the remaining battery power Br be monitored, and control be performed such that the switch 5 will be closed before the battery becomes empty and thereby the power will be received from the power source 3.

Accordingly, it is desired that the lower limit of the remaining battery power Br where it is determined to be “no remaining battery power” not be “zero”, but be a value securing the remaining amount that is sufficient to meet the demand until the next monitor time. Such a value is referred to as an allowable lower limit for remaining battery power Blim. The allowable lower limit for remaining battery power Blim is determined to have a value of the remaining battery power Br that is sufficient to cover the product of the supervisory control period T2 and a maximum dischargeable power Pmax of the battery 11 or the peak demand of the fluctuating load 13. A margin α may be added to the value for enhanced security. The allowable lower limit for remaining battery power Blim is expressed, for example, as Equation 1.

Blim=100*Pmax*T2/Brmax+α(%) (Equation 1)

In Equation 1, Brmax is a battery capacity.

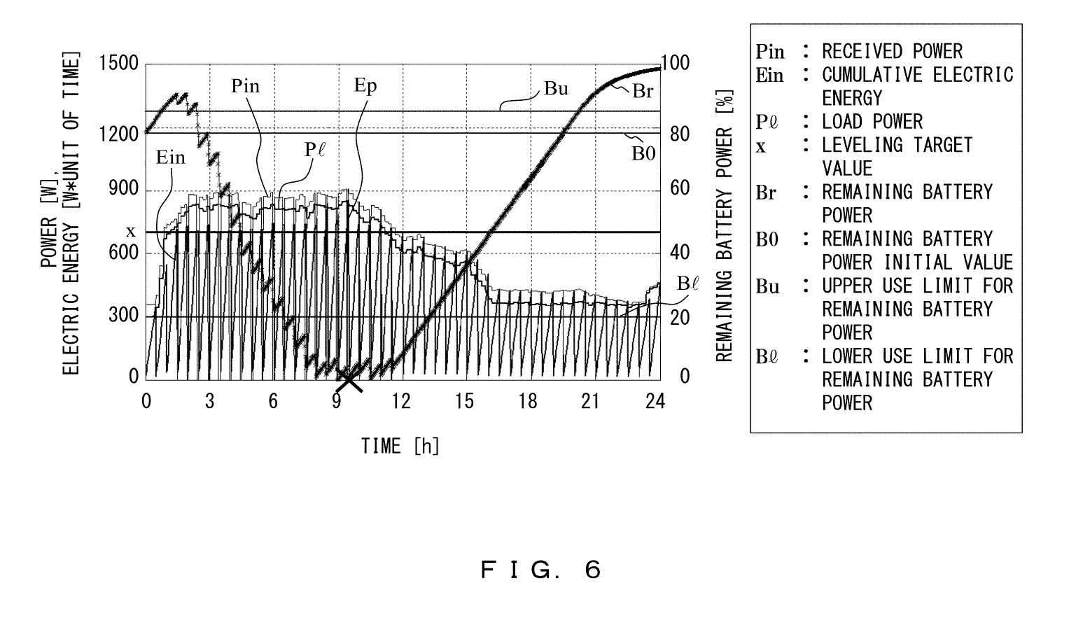

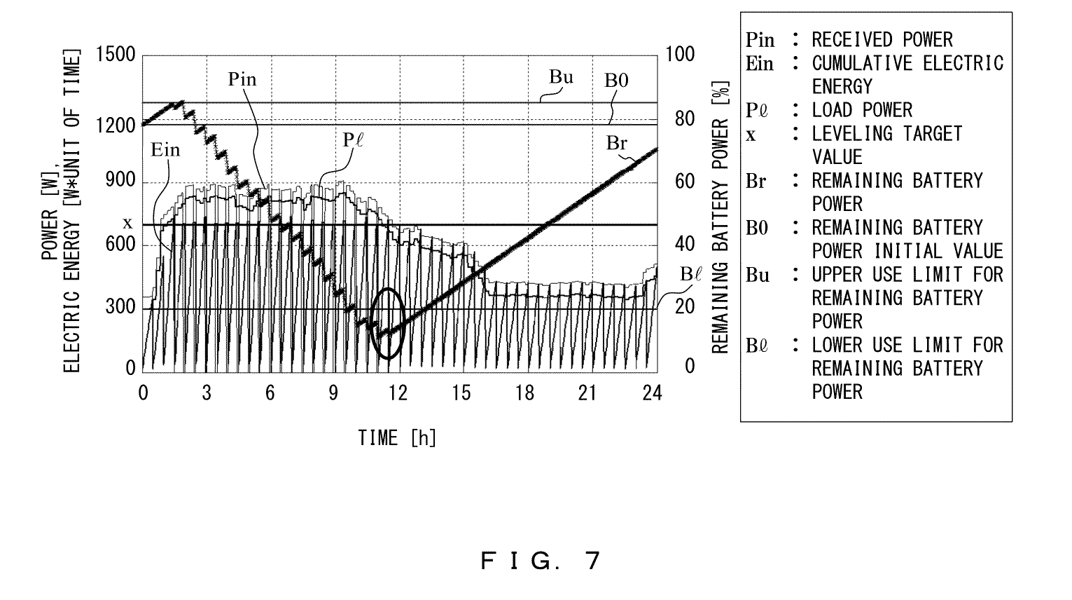

Next, a lower use limit for remaining battery power Bl will be described with reference to FIG. 6 and FIG. 7. FIG. 6 illustrates the definition of the lower use limit for the remaining battery power, and an example of the leveling control when the leveling target value x is too low. FIG. 7 illustrates an example of the determination of excess and deficiency in the status of the remaining battery power when the lower use limit for remaining battery power Bl is set. In FIG. 6 and FIG. 7, the horizontal axis represents time, and the vertical axis represents power, electric energy, and the remaining battery power. FIG. 6 and FIG. 7 illustrate an example of the changes in the received power Pin, the cumulative electric energy Ein, the load power Pl, and the remaining battery power Br over twenty-four hours as an example of the leveling cycle T0, the leveling target value x, and the remaining battery power initial value B0.

As described above with reference to FIG. 5, in the power leveling system 1 according to the first embodiment, the allowable lower limit for remaining battery power Blim is set, and when the remaining battery power becomes lower than the allowable lower limit for remaining battery power Blim, the power reception from the power source 3 starts again so as to avoid a power failure. Accordingly, when a control error has occurred in the leveling target value x and the leveling target value x becomes lower than necessary, as illustrated in FIG. 6, the remaining battery power Br may become lower than the allowable lower limit for remaining battery power Blim, and the peak of the received electric energy, such as electric energy Ep, may become high in the cumulative electric energy Ein. In order to avoid the occurrence of such a peak of the cumulative electric energy Ein, as illustrated in FIG. 7, it is desired that a value at which the remaining battery power Br is determined to be lacking be set so as to include a margin that compensates for a control error with reference to “zero”. Such a value is referred to as the lower use limit for remaining battery power Bl, and may be a specified value or a value that is determined according to the amount of the excess and deficiency of the status of the remaining battery power.

As described above, the lower use limit for remaining battery power Bl is set to the target determination unit 22 in the power leveling system 1, and it is determined that the status of the remaining battery power is lacking when the minimum value of the remaining battery power in the previous leveling cycle becomes lower than the lower use limit for remaining battery power Bl. Accordingly, the possibility that the remaining battery power Br will become “zero” is reduced, and the occurrence of a high peak of the cumulative electric energy Ein is also prevented.

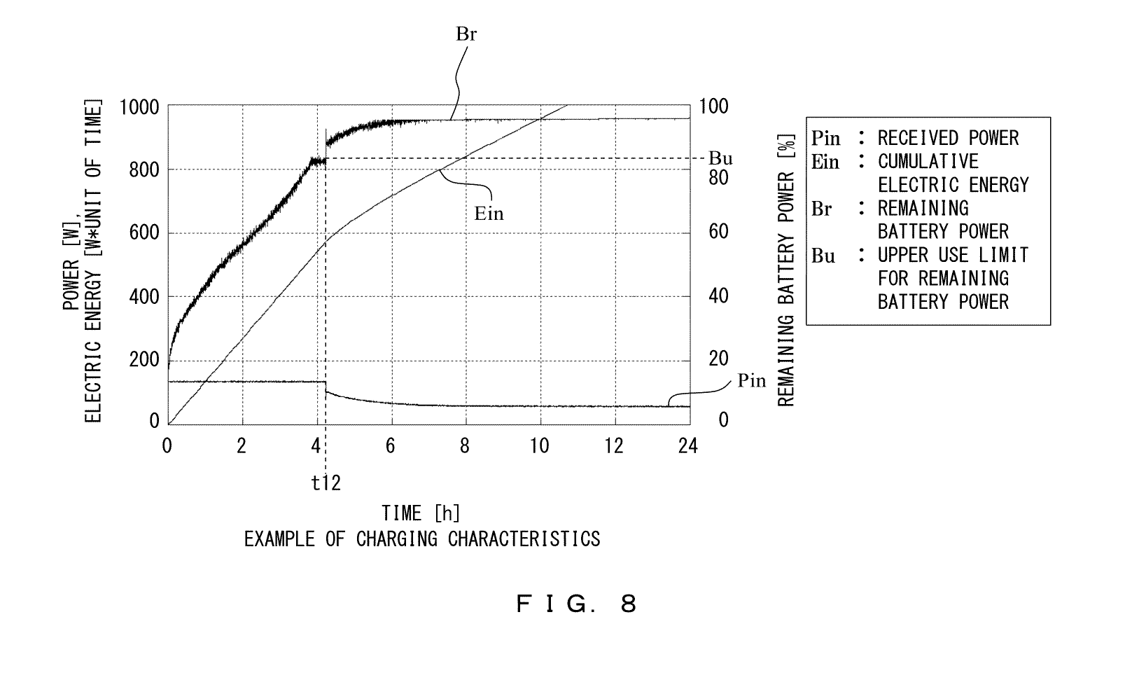

Further, an upper use limit for remaining battery power Bu will be described with reference to FIG. 8. FIG. 8 illustrates how the remaining battery power Br changes while the battery 11 is being charged. In FIG. 8, the horizontal axis represents time, and the vertical axis represents the power, the electric energy, and the remaining battery power. FIG. 8 illustrates an example of the changes in the received power Pin, the cumulative electric energy Ein, and the remaining battery power Br.

As the battery is not a power source, the power that has been discharged for leveling needs to be restored by being charged. Here, if the battery remains fully charged, there may be some cases in which charging is not possible even when power is available for charging and the dischargeable electric energy decreases. As a result, the peak reduction capability also degrades in a similar manner to the above, and thus it becomes necessary to determine that the battery is fully charged while allowing a margin for the upper limit as well, in a similar manner to the lower use limit for remaining battery power. A value used for such determination is referred to as the upper use limit for remaining battery power Bu, and is specified by the target determination unit 22 in advance. Note that a battery generally has an upper limit for the charging voltage, and when the battery is getting fully charged, a difference between the charging voltage and the voltage of the battery decreases. Accordingly, the charging current also decreases, and the charging speed slows down. In the example of FIG. 8, when the remaining battery power Br≈85 [%] at time “t=t12”, the slope of the remaining battery power Br changes, and the charging speed apparently slows down. Such an area of the storage capacity in which the charging speed slows down is referred to as a constant-voltage charging area.

When storage capacity including the constant-voltage charging area is to be used in the most effective manner, it is necessary for the power leveling system 1 to inhibit the electric energy that is discharged for leveling according to the charging speed in order to restore the discharged power within a leveling cycle. However, the charging speed of the constant-voltage charging area exponentially decreases, as illustrated in FIG. 8. Accordingly, the dischargeable electric energy significantly decreases, and the peak reduction capability also degrades. For this reason, the constant-voltage charging area is not actively used in the power leveling system 1, and the battery may be assumed to be fully charged when the remaining battery power reaches the lower limit of the constant-voltage charging area. It is preferred that the value of the remaining battery power Br at the time when the battery may be assumed to be fully charged be set to the upper use limit for remaining battery power Bu because it becomes possible to avoid degradation in performance due to the sustained stage of being fully charged and the decreased charging speed. Generally, the lower limit of a constant-voltage charging area is indicated as a specification of the battery 11.

In the power leveling system 1 as described above, the power leveling control in which the leveling target value x is determined according to the change in the remaining battery power Br over the leveling cycle T0 requires the following reference input elements. That is, a maximum value for remaining battery power Bmax, a minimum value for remaining battery power Bmin, a final remaining battery power B, and a charge and discharge balance Bd in the leveling cycle T0 are required. The final remaining battery power B indicates the remaining battery power Br at the time when the leveling cycle ends, and the charge and discharge balance Bd indicates a difference between the remaining battery power Br at the time when the leveling cycle starts and the remaining battery power Br at the time when the leveling cycle ends.

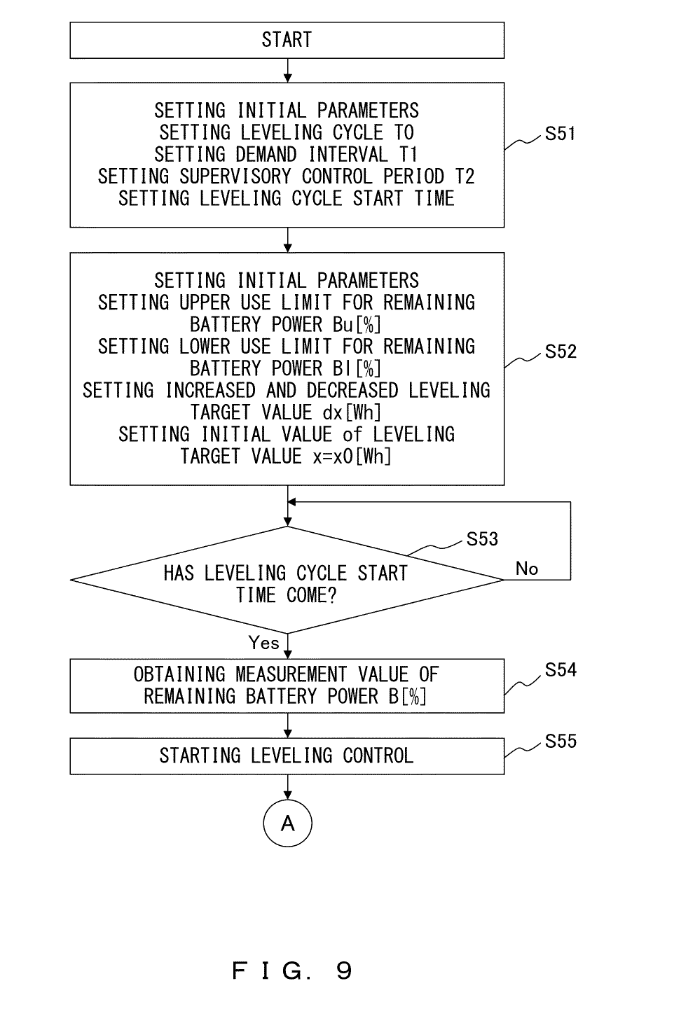

The operation of the power leveling system 1 according to the first embodiment will be described below with reference to the flowcharts of FIGS. 9-11. FIGS. 9-11 are flowcharts illustrating the operation of the power leveling system 1 according to the first embodiment. As illustrated in FIG. 9, the target determination unit 22 sets initial parameters of the power leveling control in advance (S51). That is, the leveling cycle T0, the demand interval T1, the supervisory control period T2, and leveling cycle start time are set and stored in the storage unit 24. Also, the upper use limit for remaining battery power Bu (%), the lower use limit for remaining battery power Bl (%), increased and decreased leveling target value dx(Wh), and the initial value of leveling target value x=x0(Wh), which are used to control leveling target value determination, are set and stored in the storage unit 24 (S52).

The target determination unit 22 monitors whether or not the leveling cycle start time set in S51 has come by comparing a time of a time obtaining unit (not illustrated) with the leveling cycle start time stored in the storage unit 24 (S53: “No”). When the leveling cycle start time has come (S53: “Yes”), the target determination unit 22 firstly obtains the remaining battery power B (%) as an initial value of the remaining battery power Br (S54), and starts performing leveling control (S55).

The process proceeds to that of FIG. 10, and the target determination unit 22 resets a leveling cycle timer (not illustrated) (S61). Also, the target determination unit 22 resets the maximum value for remaining battery power Bmax, the minimum value for remaining battery power Bmin, and the remaining battery power initial value B0 such that Bmax=B (%), Bmin=B (%), and B0=B, respectively (S62), and resets a demand interval timer (not illustrated) (S63). The target determination unit 22 outputs an actuating signal to the switch controller 26 so as to close the switch 5 and start power reception, and the switch 5 is closed according to the instruction signal output from the switch controller 26 (S64). The target determination unit 22 resets the parameter to the cumulative electric energy Ein=0(Wh) (S65), and resets the monitoring control cycle timer (not illustrated) (S66).

The target determination unit 22 performs monitoring until the monitoring control cycle timer ends (S67: “No”). When the monitoring control cycle timer ends (S67: “Yes”), the target determination unit 22 obtains the remaining battery power Br measured by the remaining battery power level measurement unit 12 as “B” (S68). The target determination unit 22 compares the obtained remaining battery power B with the maximum value for remaining battery power Bmax, and when the final remaining battery power B is equal to or less than the maximum value for remaining battery power Bmax, the process proceeds to S71 (S69: “Yes”). When the remaining battery power B is greater than the maximum value for remaining battery power Bmax (S69: “No”), the maximum value for remaining battery power Bmax is updated to the remaining battery power B (S70), and the process proceeds to S71. The target determination unit 22 compares the obtained remaining battery power B with the minimum value for remaining battery power Bmin, and when the remaining battery power B is equal to or greater than the minimum value for remaining battery power Bmin, the process proceeds to S73 (S71: “Yes”). When the remaining battery power B is smaller than the minimum value for remaining battery power Bmin (S71: “No”), the target determination unit 22 updates the minimum value for remaining battery power Bmin to the remaining battery power B (S72), and the process proceeds to S73. The target determination unit 22 obtains the received power Pin (W) by using the received power measurement unit 9 (S73).

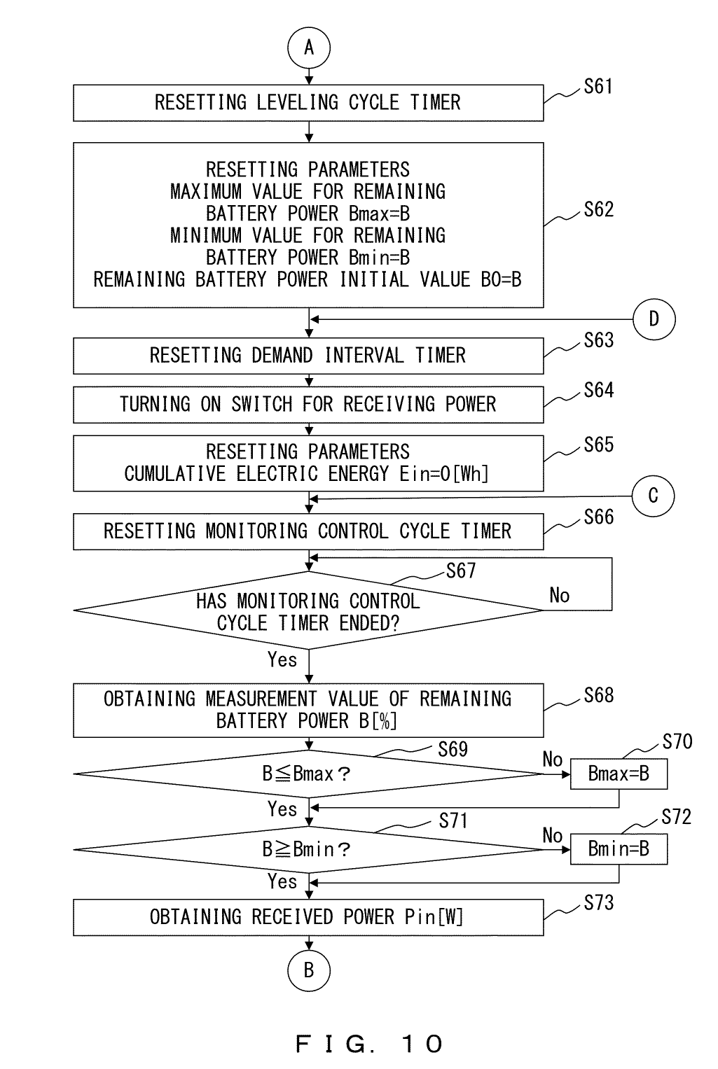

The process proceeds to that of FIG. 11, and the target determination unit 22 calculates cumulative received electric energy “Ein=Ein+Pin*T2” (S81). The switch controller 26 compares the cumulative received electric energy Ein calculated in S81 with the current leveling target value x, and when the cumulative received electric energy Ein is less than the leveling target value x (S82: “No”), the process proceeds to S84. When the cumulative received electric energy Ein calculated in S81 is equal to or greater than the leveling target value x (S82: “Yes”), the switch controller 26 outputs an actuating signal to the switch 5 so as to cut off the connection, and the switch 5 cuts off the connection. At this time, the battery detects the terminated input, and starts discharging to supply power to the load (S83).

While the target determination unit 22 determines that the demand interval timer has not ended (S84: “No”), the processes of S66 through S84 are repeated. When it is determined that the demand interval timer has terminated (S84: “Yes”), the target determination unit 22 determines whether or not the leveling cycle timer has terminated (S85). While the target determination unit 22 determines that the leveling cycle timer has not yet terminated (S85: “No”), the processes of S63 to S85 are repeated. When it is determined that the leveling cycle timer has terminated (S85: “Yes”), the target determination unit 22 calculates a balance of the remaining battery power “Bd=B−B0” (S86), and proceeds the process to the determination process of the leveling target value x (S100).

In S100, the target determination unit 22 determines whether the conditions “maximum value for remaining battery power Bmax>upper use limit for remaining battery power Bu”, “minimum value for remaining battery power Bmin>lower use limit for remaining battery power Bl”, and “charge and discharge balance Bd>0” are met (S87). When the result of the determination meets the conditions, the leveling target value is updated to “x=x−dx” (S88), and the process returns to S61. When the result of the determination does not meet the conditions, the process proceeds to S89.

The target determination unit 22 determines whether the conditions “maximum value for remaining battery power Bmax<upper use limit for remaining battery power Bu”, “minimum value for remaining battery power Bmin<lower use limit for remaining battery power Bl”, and “charge and discharge balance Bd<0” are met (S89). When the result of the determination meets at least one of the conditions, the leveling target value is updated to “x=x+dx” (S90), and the process returns to S61. When the result of the determination does not meet the conditions, the process remains at S61.

In the above processes, the target determination unit 22 performs a determination process or the like by storing the maximum value for remaining battery power Bmax, the minimum value for remaining battery power Bmin, the remaining battery power initial value B0, or the like in the storage unit 24, or by reading the maximum value for remaining battery power Bmax, the minimum value for remaining battery power Bmin, the remaining battery power initial value B0, or the like from the storage unit 24.

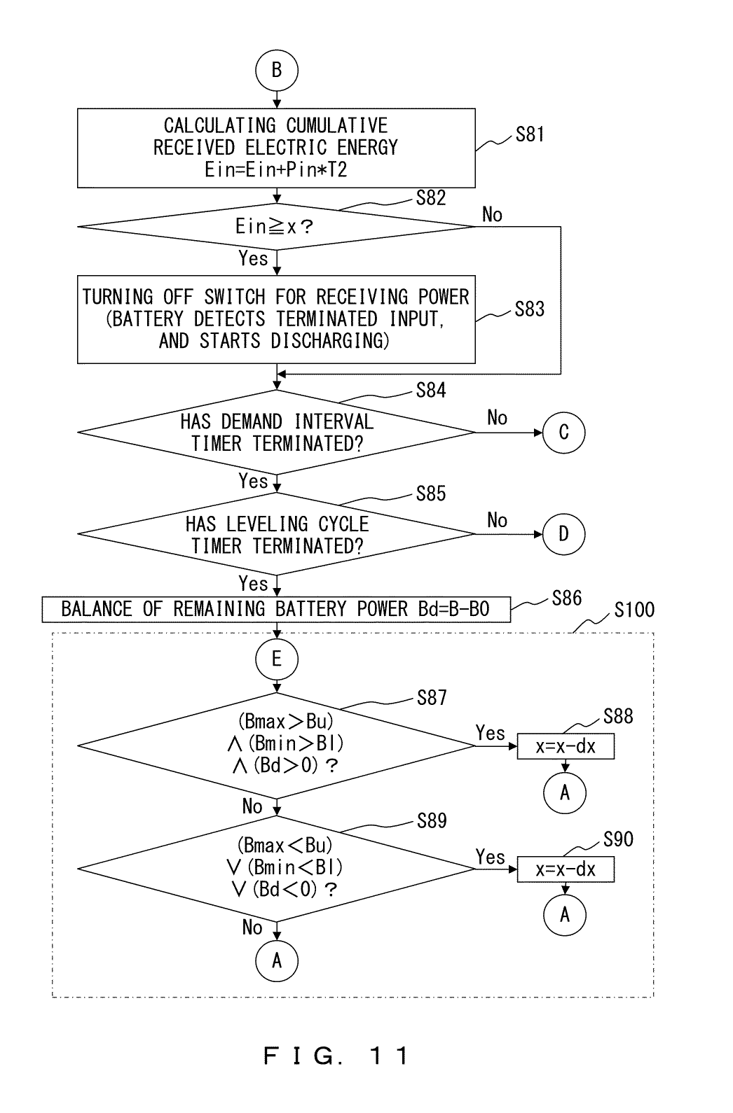

The results of the processes performed in the leveling control as above by the power leveling system 1 will be described with reference to FIGS. 12-15. FIGS. 12-15 illustrate examples of the results of the leveling control according to the first embodiment, where the horizontal axis represents time, and the vertical axis represents the power, the electric energy, and the remaining battery power. In FIGS. 12-15, how the remaining battery power Br changes in the leveling cycle T0, the remaining battery power initial value B0, the upper use limit for remaining battery power Bu, and the lower use limit for remaining battery power Bl are indicated. For the sake of comparison, the received power Pin, the cumulative received electric energy Ein, the load power Pl, and the leveling target value x are indicated.

FIG. 12 illustrates a result of the leveling control in the case where the leveling target value x is appropriate for the configuration of the fluctuating load 13 and the changes in the demand for electricity. In FIG. 12, the leveling cycle T0 is twenty-four hours. As illustrated in FIG. 12, the remaining battery power Br is “remaining battery power Br=B0” at the start of the leveling cycle T0, and the remaining battery power Br records the maximum value for remaining battery power Bmax within three hours after that. The remaining battery power Br records the minimum value for remaining battery power Bmin before twelve hours pass, and rises again and reaches the final remaining battery power B when twenty-four hours have passed at the end of the leveling cycle T0. Here, the maximum value for remaining battery power Bmax corresponds to the upper use limit for remaining battery power Bu, and the minimum value for remaining battery power Bmin corresponds to the lower use limit for remaining battery power. Moreover, the charge and discharge balance Bd is zero. Accordingly, it is considered that in this leveling cycle T0, an optimal leveling target value x is set in the power leveling system 1 according to the first embodiment, and thus the leveling target value x is not modified in the next leveling cycle T0.

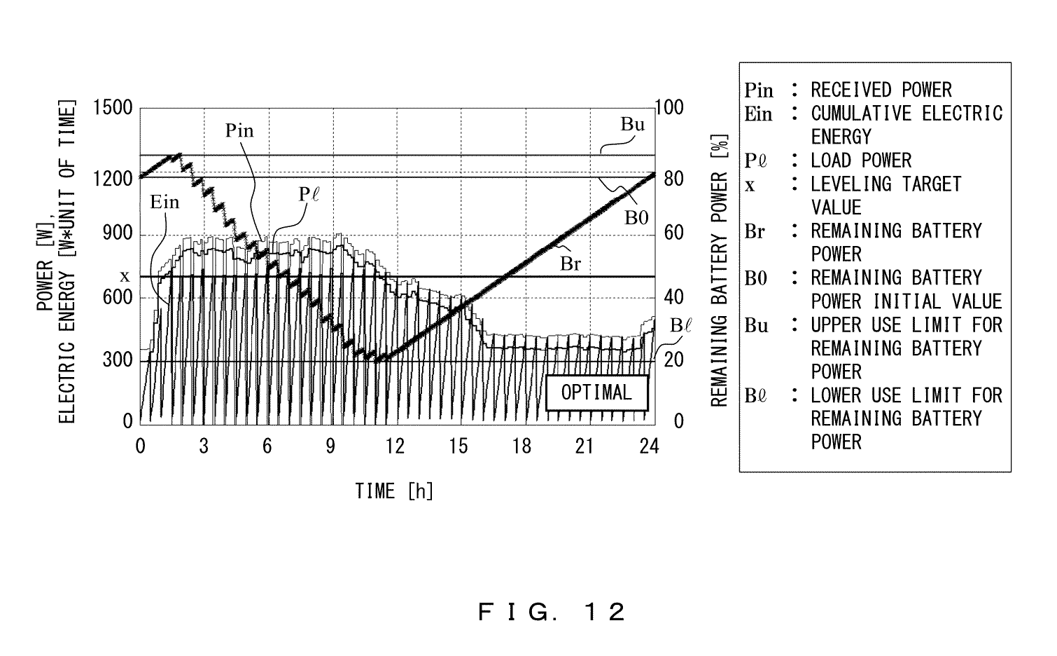

FIG. 13 illustrates an example of the results of the leveling control. In the example of FIG. 13, the minimum value for remaining battery power Bmin falls below the lower use limit for remaining battery power Bl in an area 13A. The maximum value for remaining battery power Bmax exceeds the upper use limit for remaining battery power Bu in an area 13B, and the charge and discharge balance Bd exceeds zero in an area 13C. According to a process 100 as described above, it is determined that the remaining battery power Br is lacking in such a case. Thus, the leveling target value x will be increased in the next leveling cycle T0.

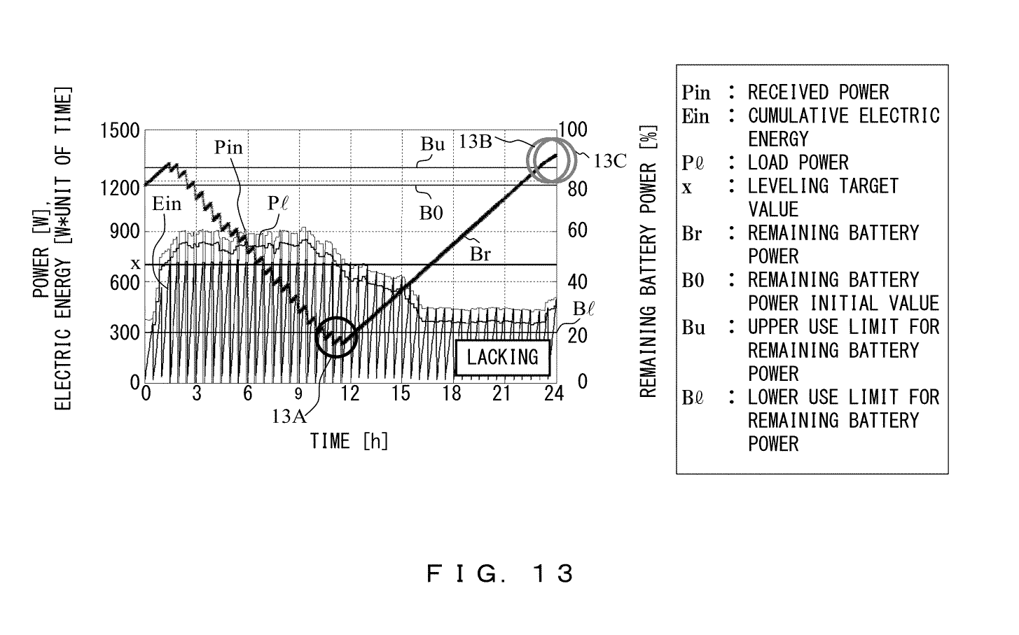

FIG. 14 illustrates another example of the results of the leveling control. In the example of FIG. 14, the maximum value for remaining battery power Bmax falls below the upper use limit for remaining battery power Bu in an area 14A. In an area 14B, the minimum value for remaining battery power Bmin exceeds the lower use limit for remaining battery power Bl. In an area 14C, the charge and discharge balance Bd is nearly zero. According to the process 100 as above, it is determined that the remaining battery power Br is neither excessive nor lacking in such a case. Thus, the leveling target value x will be maintained in the next leveling cycle T0. If the leveling target value x is once increased in such a case to make the charge and discharge balance Bd have a positive value and the leveling target value x is restored, there are some possible cases in which the remaining battery power Br will become excessive even with the same leveling target value x.

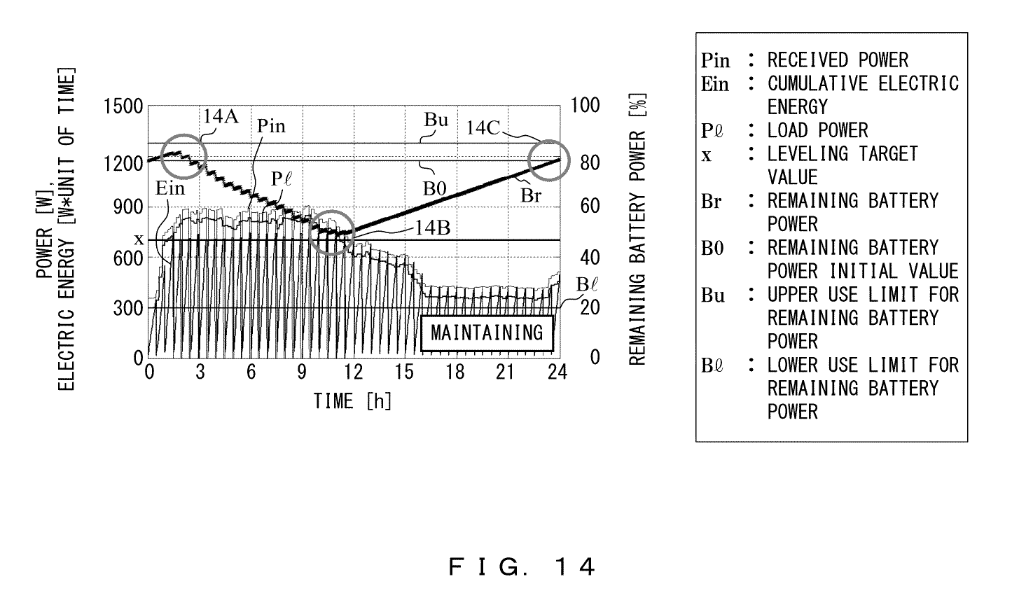

FIG. 15 illustrates yet another example of the results of the leveling control. In the example of FIG. 15, the minimum value for remaining battery power Bmin exceeds the lower use limit for remaining battery power Bl in an area 15A. The maximum value for remaining battery power Bmax exceeds the upper use limit for remaining battery power Bu in an area 15B, and the charge and discharge balance Bd exceeds zero in an area 15C. According to the process 100 as above, it is determined that the remaining battery power Br is excessive in such a case. Thus, the leveling target value x will be decreased in the next leveling cycle T0.

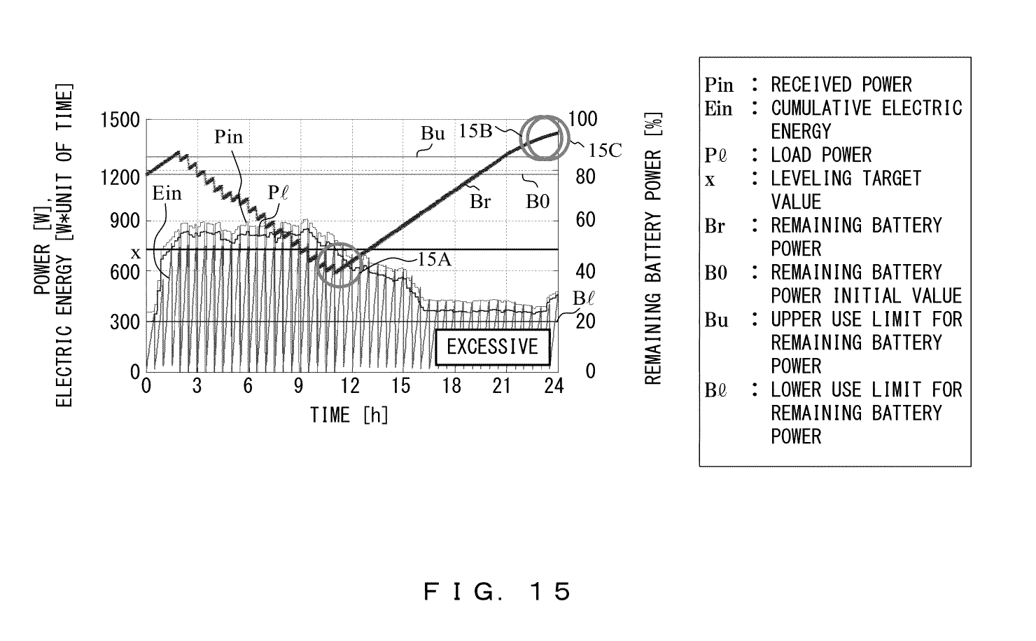

FIG. 16 illustrates an example of the result of the leveling control as above that is performed for about one thousand days. In FIG. 16, the horizontal axis represents the number of days, and the vertical axis represents the accumulated power and the remaining battery power. As illustrated in FIG. 16, before leveling control is performed, there are many days in which the peak electric energy exceeds the leveling target value x. By contrast, after leveling control is performed, there are few days in which the peak electric energy exceeds the leveling target value. In the example of FIG. 16, about a 10 percent reduction is achieved in the peak electric energy due to the leveling control.

As described above, the power leveling system 1 according to the first embodiment has the power source 3 to which the storage battery 7 and the fluctuating load 13 are connected through the switch 5, and includes the leveling controller 20 for controlling the operation of the switch 5. The leveling controller 20 updates the leveling target value x in the next leveling cycle T0 according to the maximum value for remaining battery power Bmax, the minimum value for remaining battery power Bmin, and the charge and discharge balance Bd in the leveling cycle T0. Moreover, the leveling controller 20 controls the opening and closing of the switch 5 according to the updated leveling target value x, thereby performing leveling control in the power leveling system 1.

In the power leveling system 1 according to the first embodiment, no matter how the battery 11, the loss of its charge and discharge circuit, the charging speed or the like changes, such a change will appear as an increase and decrease in the remaining battery power Br. For this reason, it is possible to determine a leveling target value in consideration of the influence of the characteristics of the power leveling system 1 without modeling such characteristics, in the power leveling control performed according to the remaining battery power by the power leveling system 1 according to the first embodiment. The power leveling system 1 performs control without relying on how the demand for electricity changes in the fluctuating load 13. The power leveling system 1 determines the leveling target value x according to the value stored in the storage unit 24 at the end of the leveling cycle T0, which represents the transition of the remaining battery power Br in the leveling cycle T0. In other words, the control only relies on whether the storage capacity is effectively being used. Accordingly, demand forecasting for the fluctuating load 13 is not necessary, and a leveling target value may be determined with a simple process. As system modeling and demand forecasting are not used, it becomes possible to perform power leveling control in a more realistic manner in terms of the power leveling system 1, and there may be an advantageous effect wherein the power consumption is reduced. In the power leveling control according to the first embodiment, a cycle in which a period in which demand for electricity is high and a period in which demand for electricity is low alternately appear is determined to be the leveling cycle T0, and the control is performed according to the changes in the remaining battery power Br in the leveling cycle T0. Accordingly, the storage capacity may be effectively utilized, and the characteristics of the changes in the load are utilized in the control.

When control is performed according to the remaining battery power Br, the lower use limit for remaining battery power Bl is set as a threshold of the minimum value for remaining battery power Bmin, which is not “zero”. Accordingly, the possibility of the remaining battery power Br becoming “zero” is reduced. Moreover, the upper use limit for remaining battery power Bu is set as a threshold of the maximum value for remaining battery power Bmax. Accordingly, it becomes possible to limit the use of the area of the remaining battery power Br in which the dischargeable electric energy significantly decreases due to the reduction in charging speed, and the leveling performance may be prevented from degrading.

(Modification 1 of First Embodiment)

Modification 1 of the power leveling system 1 according to the first embodiment will be described below. The present modification 1 is a modification of the determination process of the leveling target value x (S100), which is described in the first embodiment. In the present modification, the configuration of the power leveling system 1 and the processes other than S100 are similar to those of the first embodiment. Thus, overlapping descriptions will be omitted. In the present modification, the conditions of reference input elements described in the first embodiment are determined as follows, by increasing or decreasing the leveling target value x in the next leveling cycle T0.

Decreasing Condition) Cases in which Leveling Target Value x is Decreased

Condition 1a) Maximum value for remaining battery power Bmax>Upper use limit for remaining battery power Bu

Condition 1b) Minimum value for remaining battery power Bmin>Lower use limit for remaining battery power Bl

Condition 1c) Charge and discharge balance Bd>0

Condition 1d) Final remaining battery power B>Upper use limit for remaining battery power Bu

Increasing Condition) Cases in which Leveling Target Value x is Increased

Condition 2a) Maximum value for remaining battery power Bmax<Upper use limit for remaining battery power Bu

Condition 2b) Minimum value for remaining battery power Bmin<Lower use limit for remaining battery power Bl

Condition 2c) Charge and discharge balance Bd<0

Condition 2d) Final remaining battery power B<Upper use limit for remaining battery power Bu

At least one of the four decreasing conditions and at least one of the four increasing conditions are selected, respectively, as a determining condition. When two or more conditions are selected, their logical sum or logical product is taken. In the present modification, for example, when there is an insufficient margin in the storage capacity, an increasing condition for increasing the leveling target value x is prioritized so as to avoid power failure, and a logical product is taken in a decreasing condition and a logical sum is taken in an increasing condition. Accordingly, fifteen patterns of conditions are obtained for the decreasing conditions and the increasing conditions, respectively. Further, if cases in which whether a decreasing condition is satisfied are firstly determined, i.e., cases in which a condition for increasing the leveling target value x is satisfied are firstly determined, and cases in which whether an increasing condition is satisfied are firstly determined are taken into consideration, “15*15*2=450” patterns of conditions are obtained. These conditions are all applicable to the power leveling system 1, and included in the modification 1 of the first embodiment. Note that these 450 patterns include determining conditions of the leveling target value x, which are described in the first embodiment.

The conditions described in the first embodiment are expressed as follows.

Decreasing condition): Condition 1a, AND condition 1b, AND condition 1c (logical product)

Increasing condition): Condition 2a, OR condition 2b, OR condition 2c (logical sum)

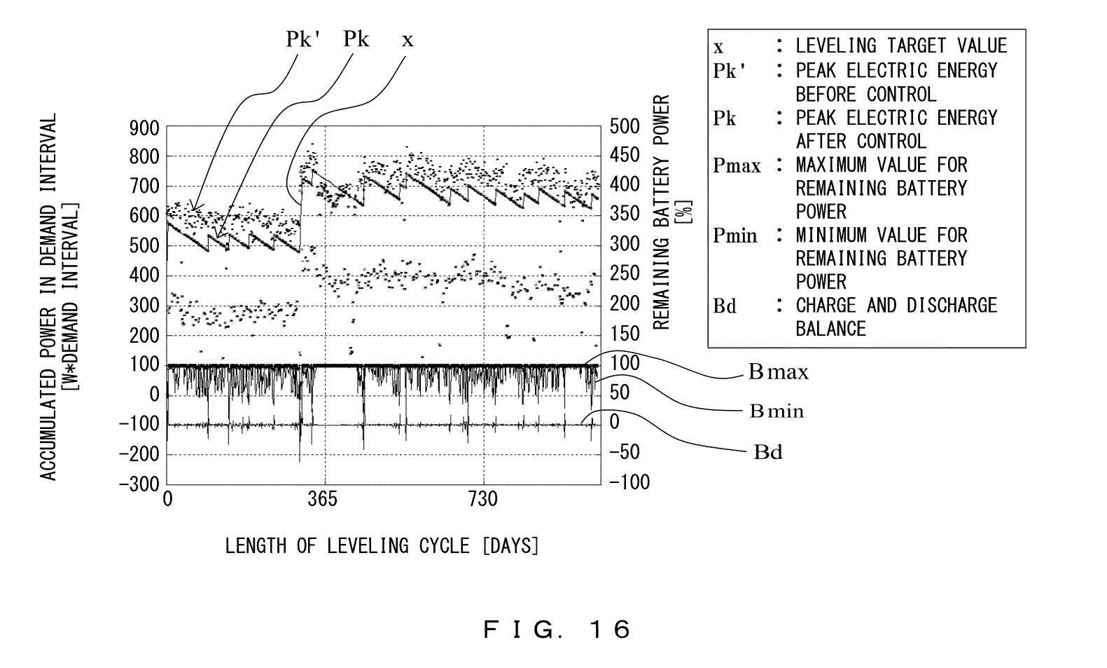

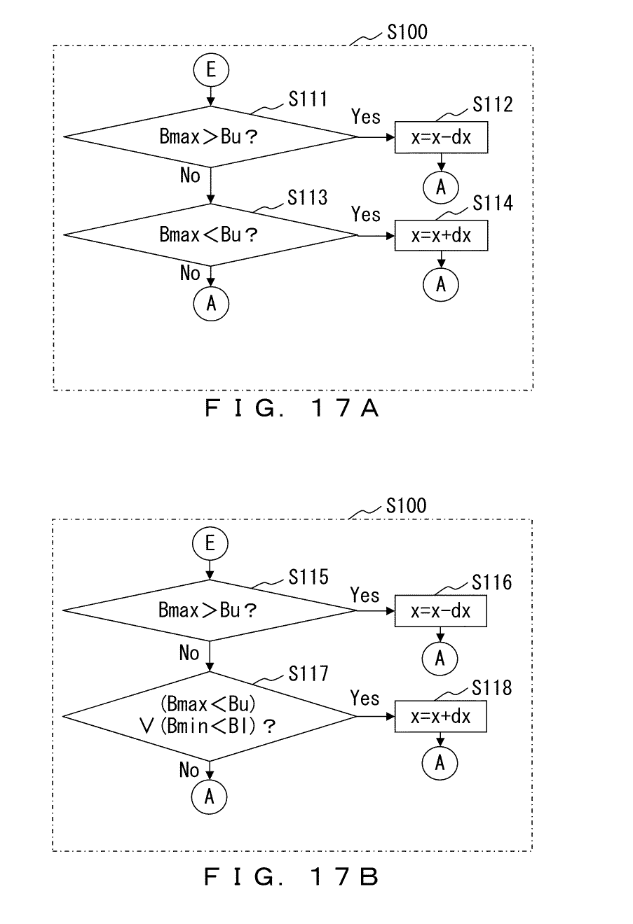

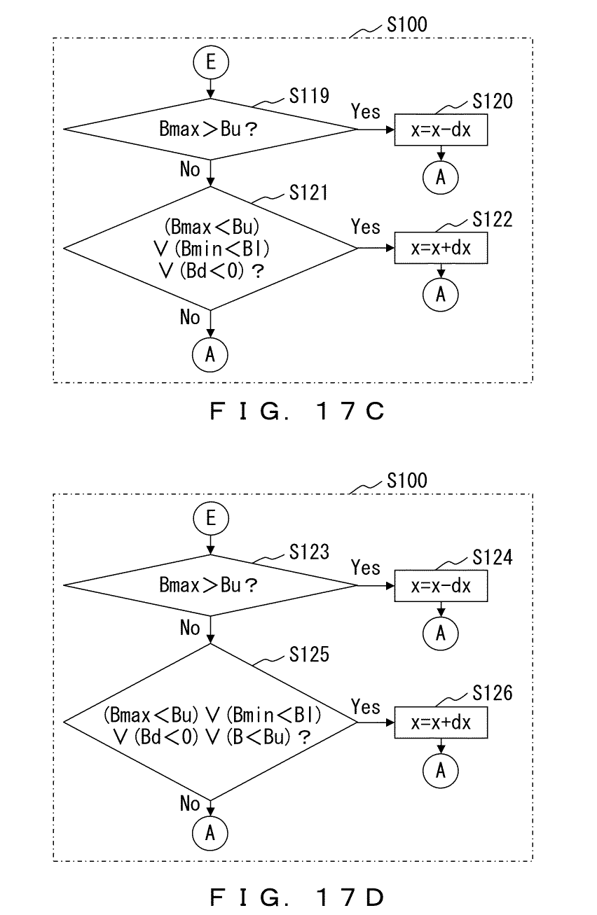

Some examples from the above 450 patterns will be described. Firstly, an example in which a process to determine whether or not the leveling target value x is to be decreased is firstly performed will be described with reference to FIG. 17A˜17D. FIG. 17A-17D illustrates examples in which the condition 1a is adopted from the decreasing conditions and the condition adopted from the increasing conditions is changed. FIG. 17A illustrates an example in which one condition is adopted, and FIG. 17B illustrates an example in which two conditions are adopted. FIG. 17C illustrates an example in which three conditions are adopted, and FIG. 17D illustrates an example in which four conditions are adopted.

In FIG. 17A, one condition is adopted from each of the decreasing conditions and increasing conditions. As illustrated in FIG. 17A, the target determination unit 22 determines whether or not “maximum value for remaining battery power Bmax>upper use limit for remaining battery power Bu” holds true. When the condition is satisfied (S111: “Yes”), the leveling target value is updated to “x=x−dx” (S112), and the process returns to S61 of FIG. 10. When the condition is not satisfied (S111: “No”), the process proceeds to S113. Subsequently, the target determination unit 22 determines whether or not “maximum value for remaining battery power Bmax<upper use limit for remaining battery power Bu” holds true. When the condition is satisfied (S113: “Yes”), the leveling target value is updated to “x=x+dx” (S114), and the process returns to S61 of FIG. 10. When the condition is not satisfied (S113: “No”), the process just returns to S61.

In FIG. 17B, one condition is adopted from the decreasing conditions, and two conditions are adopted from the increasing conditions. As illustrated in FIG. 17B, the target determination unit 22 determines whether or not “maximum value for remaining battery power Bmax>upper use limit for remaining battery power Bu” holds true. When the condition is satisfied (S115: “Yes”), the leveling target value is updated to “x=x−dx” (S116), and the process returns to S61 of FIG. 10. When the condition is not satisfied (S115: “No”), the process proceeds to S117. Subsequently, the target determination unit 22 determines whether or not “maximum value for remaining battery power Bmax<upper use limit for remaining battery power Bu” or “minimum value for remaining battery power Bmin<lower use limit for remaining battery power Bl” holds true. When the condition is satisfied (S117: “Yes”), the leveling target value is updated to “x=x+dx” (S118), and the process returns to S61 of FIG. 10. When the condition is not satisfied (S117: “No”), the process just returns to S61.

In FIG. 17C, one condition is adopted from the decreasing conditions, and three conditions are adopted from the increasing conditions. As illustrated in FIG. 17C, the target determination unit 22 determines whether or not “maximum value for remaining battery power Bmax>upper use limit for remaining battery power Bu” holds true. When the condition is satisfied (S119: “Yes”), the leveling target value is updated to “x=x−dx” (S120), and the process returns to S61 of FIG. 10. When the condition is not satisfied (S119: “No”), the process proceeds to S121. Subsequently, the target determination unit 22 determines whether or not “maximum value for remaining battery power Bmax<upper use limit for remaining battery power Bu” or “minimum value for remaining battery power Bmin<lower use limit for remaining battery power Bl”, or “charge and discharge balance Bd<0” holds true (S121). When the condition is satisfied (S121: “Yes”), the leveling target value is updated to “x=x+dx” (S122), and the process returns to S61 of FIG. 10. When the condition is not satisfied (S121: “No”), the process just returns to S61.

In FIG. 17D, one condition is adopted from the decreasing conditions, and four conditions are adopted from the increasing conditions. As illustrated in FIG. 17D the target determination unit 22 determines whether or not “maximum value for remaining battery power Bmax>upper use limit for remaining battery power Bu” holds true. When the condition is satisfied (S123: “Yes”), the leveling target value is updated to “x=x−dx” (S124), and the process returns to S61 of FIG. 10. When the condition is not satisfied (S123: “No”), the process proceeds to S125. Subsequently, the target determination unit 22 determines whether or not “maximum value for remaining battery power Bmax<upper use limit for remaining battery power Bu” or “minimum value for remaining battery power Bmin<lower use limit for remaining battery power Bl”, or “charge and discharge balance Bd<0” or “final remaining battery power B<upper use limit for remaining battery power Bu” holds true (S125). When the condition is satisfied (S125: “Yes”), the leveling target value is updated to “x=x+dx” (S126), and the process returns to S61 of FIG. 10. When the condition is not satisfied (S125: “No”), the process just returns to S61.

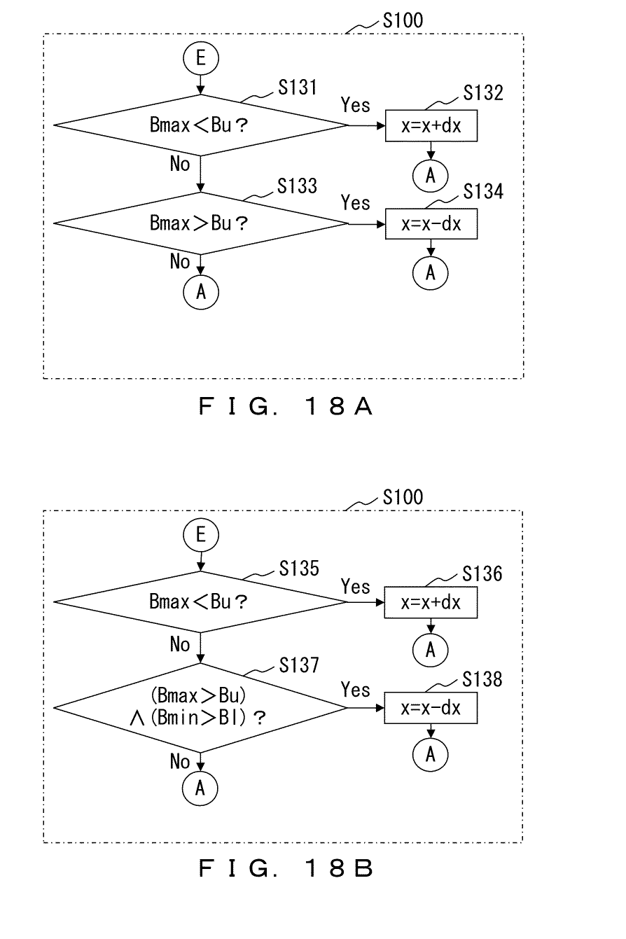

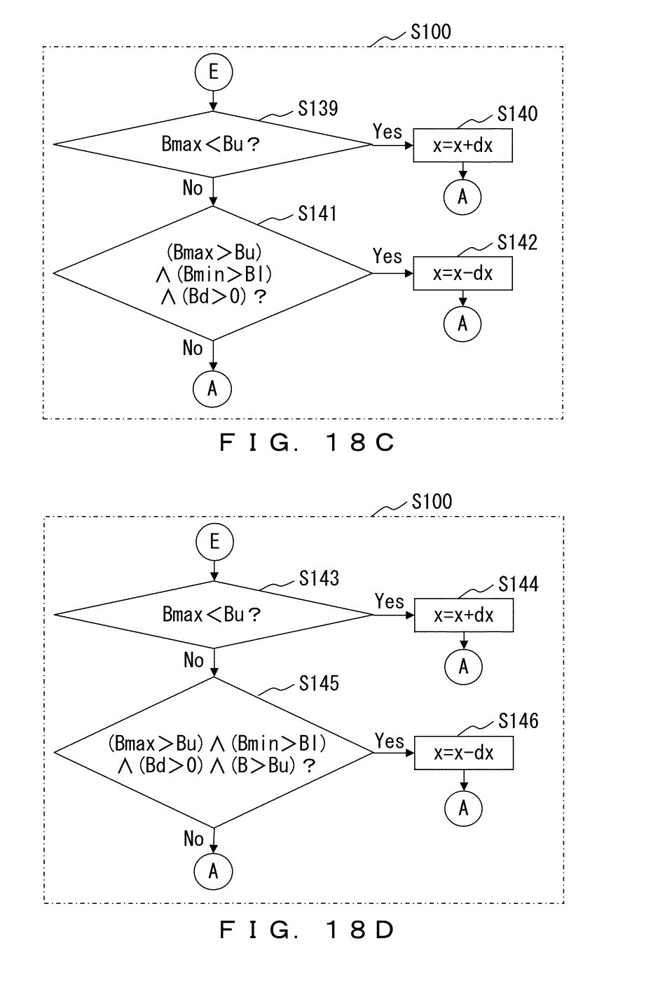

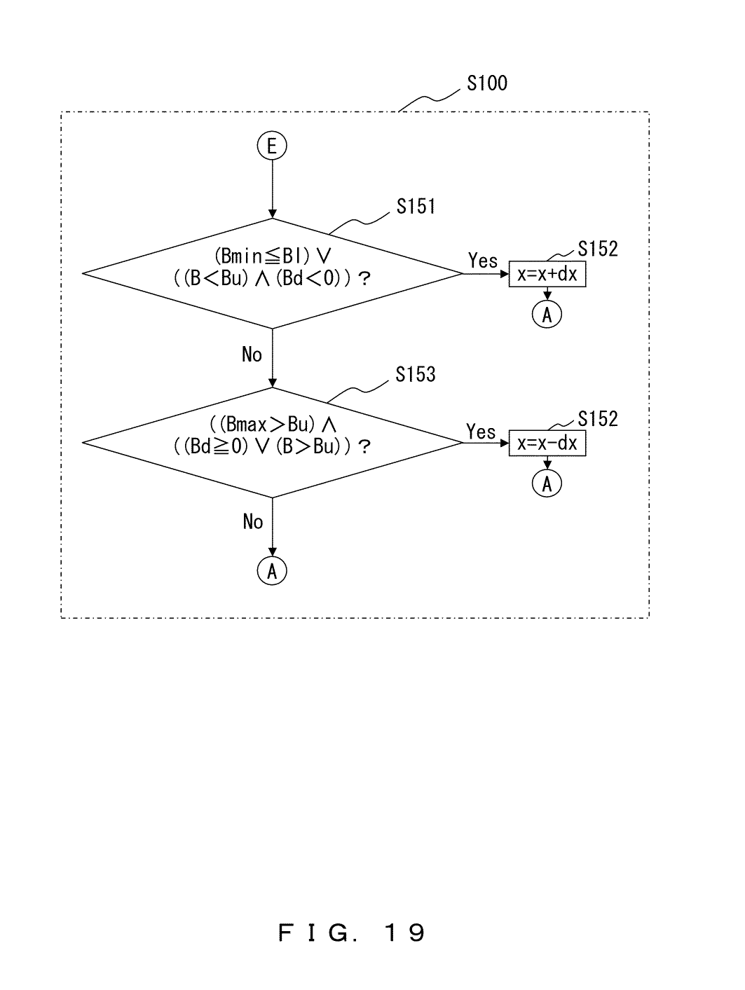

Next, a case in which a process of increasing the leveling target value x is firstly performed will be described with reference to FIG. 18A-18D. FIG. 18A-18D illustrates examples in which the condition 2a is adopted from the increasing conditions and the condition adopted from the decreasing conditions is changed. FIG. 18A illustrates an example in which one condition is adopted, and FIG. 18B illustrates an example in which two conditions are adopted. FIG. 18C illustrates an example in which three conditions are adopted, and FIG. 18D illustrates an example in which four conditions are adopted.

In FIG. 18A, one condition is adopted from each of the decreasing conditions and increasing conditions. As illustrated in FIG. 18A, the target determination unit 22 determines whether or not “maximum value for remaining battery power Bmax<upper use limit for remaining battery power Bu” holds true. When the condition is satisfied (S131: “Yes”), the leveling target value is updated to “x=x+dx” (S132), and the process returns to S61 of FIG. 10. When the condition is not satisfied (S131: “No”), the process proceeds to S133. Subsequently, the target determination unit 22 determines whether or not “maximum value for remaining battery power Bmax>upper use limit for remaining battery power Bu” holds true. When the condition is satisfied (S133: “Yes”), the leveling target value is updated to “x=x−dx” (S134), and the process returns to S61 of FIG. 10. When the condition is not satisfied (S133: “No”), the process just returns to S61.

In FIG. 18B, one condition is adopted from the increasing conditions, and two conditions are adopted from the decreasing conditions. As illustrated in FIG. 18B, the target determination unit 22 determines whether or not “maximum value for remaining battery power Bmax<upper use limit for remaining battery power Bu” holds true. When the condition is satisfied (S135: “Yes”), the leveling target value is updated to “x=x+dx” (S136), and the process returns to S61 of FIG. 10. When the condition is not satisfied (S135: “No”), the process proceeds to S137. Subsequently, the target determination unit 22 determines whether or not “maximum value for remaining battery power Bmax>upper use limit for remaining battery power Bu” and “minimum value for remaining battery power Bmin>lower use limit for remaining battery power Bl” hold true. When the conditions are satisfied (S137: “Yes”), the leveling target value is updated to “x=x−dx” (S138), and the process returns to S61 of FIG. 10. When the condition is not satisfied (S137: “No”), the process just returns to S61.

In FIG. 18C, one condition is adopted from the increasing conditions, and three conditions are adopted from the decreasing conditions. As illustrated in FIG. 18C, the target determination unit 22 determines whether or not “maximum value for remaining battery power Bmax<upper use limit for remaining battery power Bu” holds true. When the condition is satisfied (S139: “Yes”), the leveling target value is updated to “x=x+dx” (S140), and the process returns to S61 of FIG. 10. When the condition is not satisfied (S139: “No”), the process proceeds to S141. Subsequently, the target determination unit 22 determines whether or not “maximum value for remaining battery power Bmax>upper use limit for remaining battery power Bu” and “minimum value for remaining battery power Bmin>lower use limit for remaining battery power Bl”, and “charge and discharge balance Bd>0” hold true (S141). When the conditions are satisfied (S141: “Yes”), the leveling target value is updated to “x=x−dx” (S142), and the process returns to S61 of FIG. 10. When the condition is not satisfied (S141: “No”), the process just returns to S61.

In FIG. 18D, one condition is adopted from the increasing conditions, and four conditions are adopted from the decreasing conditions. As illustrated in FIG. 18D the target determination unit 22 determines whether or not “maximum value for remaining battery power Bmax<upper use limit for remaining battery power Bu” holds true. When the condition is satisfied (S143: “Yes”), the leveling target value is updated to “x=x+dx” (S144), and the process returns to S61 of FIG. 10. When the condition is not satisfied (S145: “No”), the process proceeds to S145. Subsequently, the target determination unit 22 determines whether or not “maximum value for remaining battery power Bmax>upper use limit for remaining battery power Bu” and “minimum value for remaining battery power Bmin>lower use limit for remaining battery power Bl”, and “charge and discharge balance Bd>0” and “final remaining battery power B>upper use limit for remaining battery power Bu” hold true (S145). When the conditions are satisfied (S145: “Yes”), the leveling target value is updated to “x=x−dx” (S146), and the process returns to S61 of FIG. 10. When the condition is not satisfied (S145: “No”), the process just returns to S61.

As described above, according to the modification 1 of the first embodiment, it becomes possible to achieve advantageous effects that are different in their degrees but are similar to those of the power leveling system 1 according to the first embodiment.

Note that, for example, when there is a sufficient margin in the storage capacity, the decreasing conditions for decreasing the leveling target value x are prioritized, and similar advantageous effects may be achieved even if the logical product and the logical sum are reversed. In the present modification, only inequality signs are used in the conditions. However, it is possible to achieve similar advantageous effects regardless of whether an equals sign is included. In other words, an equals sign may be included in any condition.

(Modification 2 of First Embodiment)

A modification 2 of the first embodiment will be described below. In the modification 2 of the first embodiment, overlapping descriptions will be omitted for the configurations and operations similar to those of the first embodiment and its modification 1.

FIG. 19 is a flowchart illustrating how the leveling target value x is determined in the modification 2 of the first embodiment. FIG. 19 illustrates the processes in S100 of the flowchart according to the first embodiment. How the leveling target value x is determined in the modification 2 of the first embodiment will be described by referring to the conditions that have been described in the first embodiment.

In FIG. 19, three conditions are adopted for both the decreasing condition and increasing condition. As illustrated in FIG. 19, the target determination unit 22 determines whether or not “minimum value for remaining battery power Bmin lower use limit for remaining battery power Bl”, or “final remaining battery power B<upper use limit for remaining battery power Bu” and “charge and discharge balance Bd<0” holds true. When the condition is satisfied (S151: “Yes”), the leveling target value is updated to “x=x+dx” (S152), and the process returns to S61 of FIG. 10. When the condition is not satisfied (S151: “No”), the process proceeds to S153. Subsequently, the target determination unit 22 determines whether or not “maximum value for remaining battery power Bmax>upper use limit for remaining battery power Bu” and “charge and discharge balance Bd 0” or “final remaining battery power B>upper use limit for remaining battery power Bu” holds true (S153). When the condition is satisfied (S153: “Yes”), the leveling target value is updated to “x=x−dx” (S154), and the process returns to S61 of FIG. 10. When the condition is not satisfied (S153: “No”), the process just returns to S61.

As described above, according to how the leveling target value x is determined in the modification 2 of the first embodiment, advantageous effects that are similar to those of the first embodiment and its modification may be achieved, and power leveling control that is further suitable for the actual power leveling system 1 may be realized.

Note that in the modification 2 of the first embodiment, it is possible to achieve similar advantageous effects regardless of whether an equals sign is included or not included in each condition. Thus, it does not matter whether an equals sign is or is not included in any condition. Also note that, for example, when there is a sufficient margin in the storage capacity, the decreasing conditions for decreasing the leveling target value x are prioritized, and similar advantageous effects may be achieved even if the logical product and the logical sum are reversed. Further, note that similar advantageous effects, though their degrees vary, may be achieved even if the priority or combination of the logical sum and logical product of the conditions are modified as necessary.

### Second Embodiment

A power leveling system according to the second embodiment will be described below. In the present embodiment, overlapping descriptions for the configurations and operations similar to those of the first embodiment and its modifications 1 and 2 will be omitted.

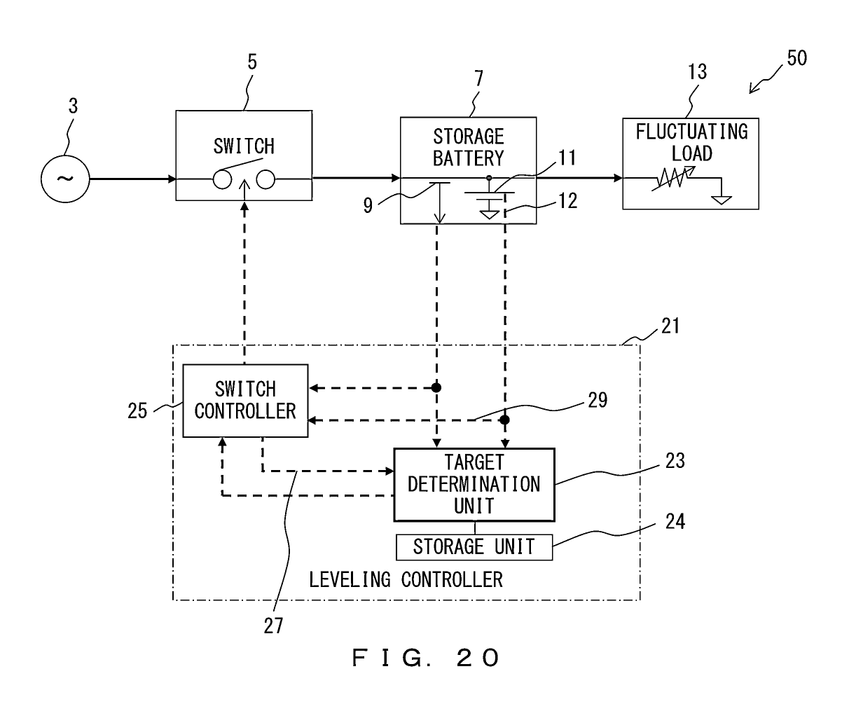

FIG. 20 illustrates the configuration of a power leveling system 50 according to the second embodiment. The configuration of the power leveling system 50 according to the second embodiment is very much similar to that of the power leveling system 1 according to the first embodiment and its modification 1 and modification 2, but further includes a target determination unit 23 and a leveling controller 21 having a switch controller 25 in place of the target determination unit 22 and the switch controller 26, respectively.

As illustrated in FIG. 20, the switch controller 25 is configured to output the switch status of the switch 5 to the target determination unit 23 in the power leveling system 50, as indicated by an arrow 27. The target determination unit 23 detects a discharge of the battery 11 according to the obtained switch status, and stores the record of the discharge in the storage unit 24. Moreover, the target determination unit 23 stores the received power Pin in the storage unit 24, and calculates a peak value CF (ratio of an average of cumulative electric energy Eav to a peak of cumulative electric energy Epk) according to the stored received power Pin. In the power leveling system 50 according to the second embodiment, determination conditions are further added in addition to the increasing conditions and decreasing conditions for the leveling target value x.

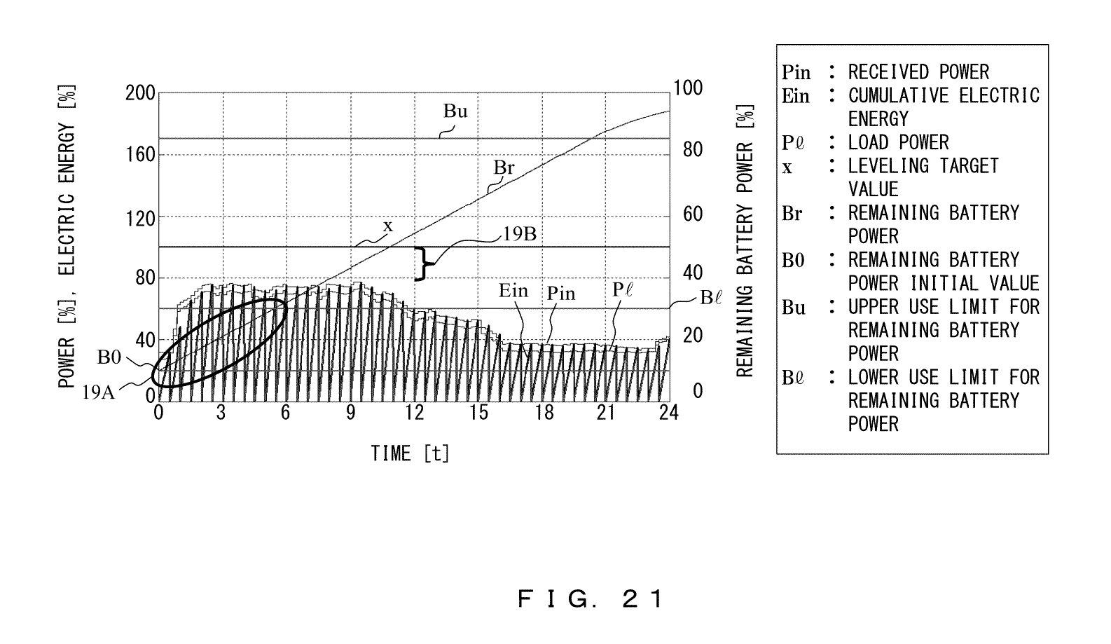

Firstly, a condition for increment determination will be described with reference to FIG. 21. A condition for increment determination to be newly added indicates that the target value is too high in the determination of the leveling target value x when a discharge never occurs even if the minimum value for remaining battery power Bmin falls below the lower use limit for remaining battery power Bl, and thus the condition indicates a non-increase.

FIG. 21 indicates how the remaining battery power Br changes in the leveling cycle T0, the remaining battery power initial value B0, the upper use limit for remaining battery power Bu, and the lower use limit for remaining battery power Bl in cases where discharge never occurs in the leveling cycle T0. For the sake of comparison, the received power Pin, the cumulative electric energy Ein, the load power Pl, and the leveling target value x are indicated.

As illustrated in FIG. 21, “remaining battery power Br<lower use limit for remaining battery power Bl” holds true in an area 19A including the start point of the leveling cycle T0. Accordingly, “minimum value for remaining battery power Bmin<lower use limit for remaining battery power Bl” holds true for the remaining battery power Br of FIG. 21, and the remaining battery power Br of FIG. 21 satisfies the condition for increasing the leveling target value x according to, for example, the first embodiment. However, a discharge never occurs in the example of FIG. 21 because the leveling target value x is higher than the peak of the received electric energy in the leveling cycle. For this reason, for example, a range 19B illustrated in FIG. 21 is considered to be a range in which the leveling target value x is excessively high, and it is apparently not necessary to increase the leveling target value x in the example of FIG. 21. In other words, when a discharge never occurs in the leveling cycle T0, it is preferred that the leveling target value x not be increased. For this reason, a discharge flag Fdc is set, and discharge is recorded by storing the discharge flag “Fdc=1” in the storage unit 24 when the switch 5 is disconnected while leveling control is being performed by the power leveling system 50. Then, the discharge flag Fdc is used as one condition for determining the leveling target value x. Note that a reset is performed by adopting “Fdc=0” at the start point of the leveling cycle.

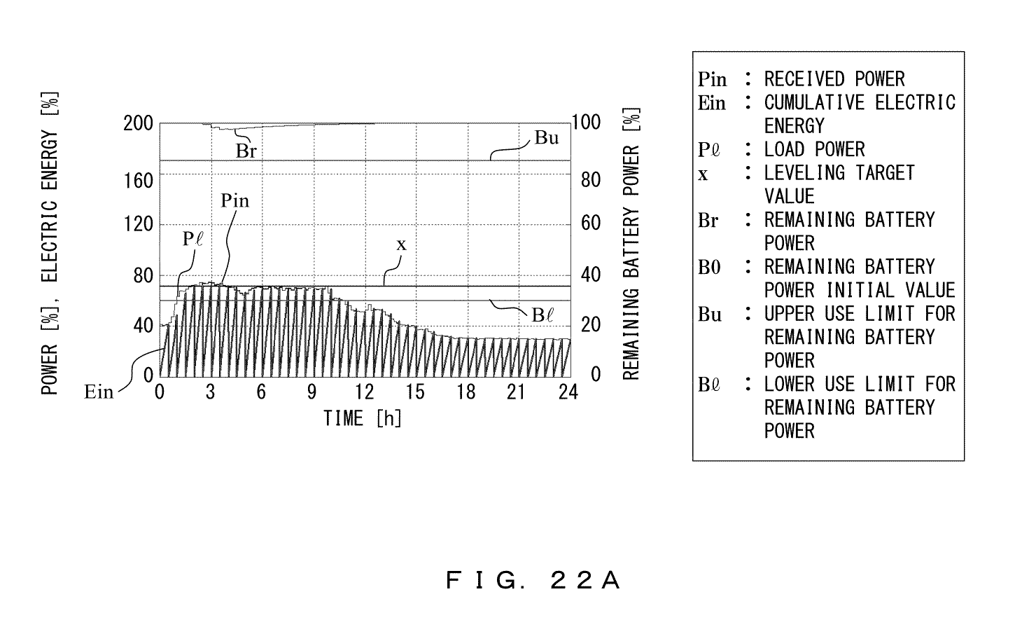

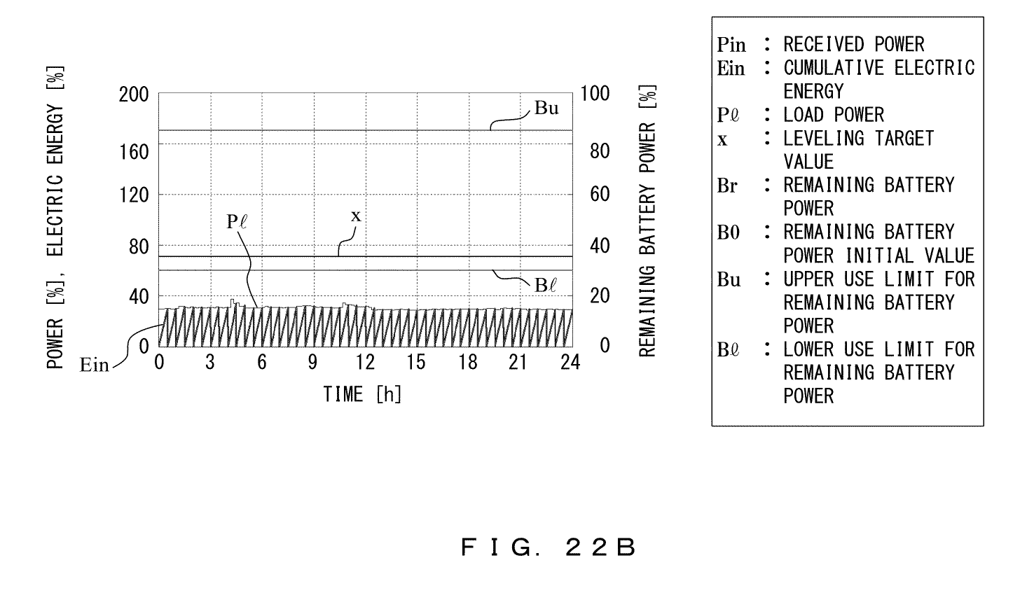

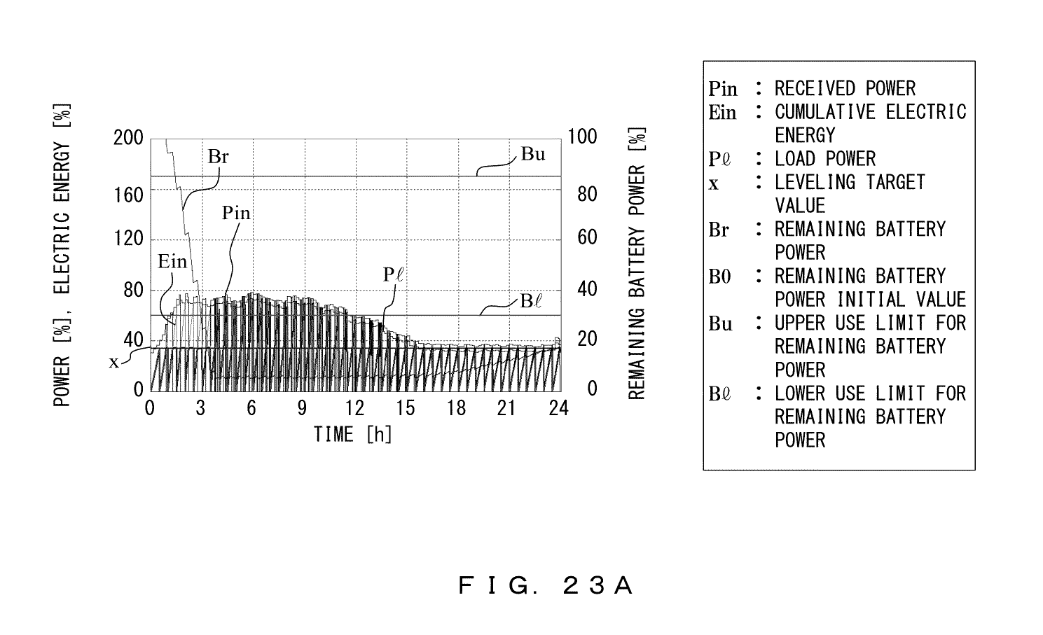

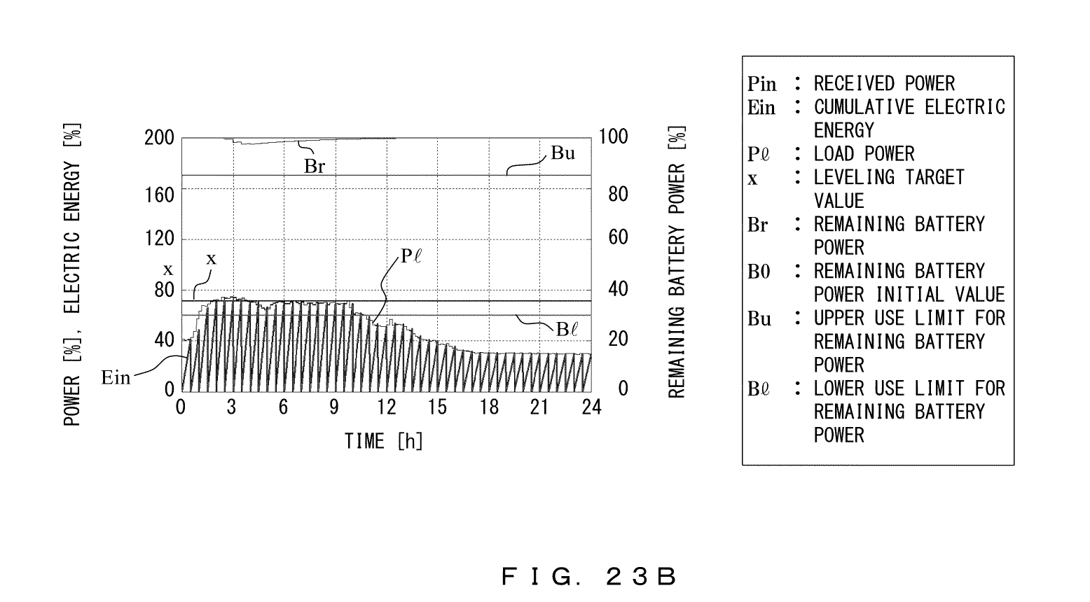

Next, a condition for decrement determination of the leveling target value x will be described with reference to FIGS. 22 and 23. A condition to be newly added indicates that the leveling target value x is not to be decreased when a ratio of a peak of the cumulative received electric energy Ein to an average of the received power in the leveling cycle T0 is smaller than a specified value.

FIG. 22A-22B and FIG. 23A-23B illustrate the received power Pin, the cumulative received electric energy Ein, the load power Pl, the remaining battery power Br, and the leveling target value x corresponding to the operating conditions of the fluctuating load 13 in the leveling cycle T0, and illustrate the continuous leveling cycle T0. FIG. 22A indicates the first leveling cycle T0, and FIG. 22B indicates the second leveling cycle T0. FIG. 23A˜23B indicates the third leveling cycle T0, where FIG. 23A indicates a case in which the leveling target value x is decreased and FIG. 23B indicates a case in which the leveling target value x is maintained.

As illustrated in FIG. 22A, the first leveling cycle T0 is, for example, a weekday, and the fluctuating load 13 is in an operating state. In FIG. 22A, the remaining battery power Br is excessive throughout the leveling cycle T0, and for example, a condition for decreasing the leveling target value x in the first embodiment is satisfied. Accordingly, the leveling target value x decreases in the second leveling cycle T0 of FIG. 22B. In the second leveling cycle T0, it is assumed that the fluctuating load 13 stops operating, for example, due to a holiday. However, the remaining battery power Br is still excessive in spite of the non-operating load, and a condition for decreasing the leveling target value x in the first embodiment is satisfied. For this reason, the leveling target value x is further decreased in the third leveling cycle T0 (FIG. 23A).

Assuming that the fluctuating load 13 is operating in the third leveling cycle T0, the leveling target value x will thereby be too low and the remaining battery power Br will be rapidly reduced due to discharge, thereby causing a shortage, as illustrated in FIG. 23A. In the leveling cycle T0 where the fluctuating load 13 is not operating as above, it is not necessary to perform leveling because the demand is low in the first place. Thus, target determination control is terminated. In other words, it is preferred that the leveling target value x not be reduced in the next leveling cycle T0, preventing the leveling target value x from becoming too low.

It is determined that the fluctuating load 13 is not operating when a peak value CF in the leveling cycle T0 falls below a specified operation determination threshold Scf. In actuality, there are some cases in which the fluctuating load 13 is operating even when the peak value CF is small. However, a small peak value CF indicates that the load fluctuation is already leveled out. Such cases are considered to be non-operating cases because it is not very meaningful to reduce the leveling target value x. If the detection of a non-operating state simply relies on the level of an average of cumulative electric energy Eav or a peak of cumulative electric energy Epk, cases in which the load power is actually decreased will be considered to be non-operating cases. Hence, it is preferred to adopt the determination in which a peak value is used as above.

Note that the demand tendency of the load is not accurately reflected in the received power NI due to the charge and discharge performed by the leveling control. For this reason, it is preferred that a peak value CF be calculated according to a load power measurement value, instead of the received power, in a system that has a unit to measure the load power, for the sake of increasing the precision of detecting a non-operating state. The power leveling system 50 according to the second embodiment is preferable in terms of the simplification of a system because operation determination may be realized by using a received power measurement unit that is already provided to perform the leveling control.

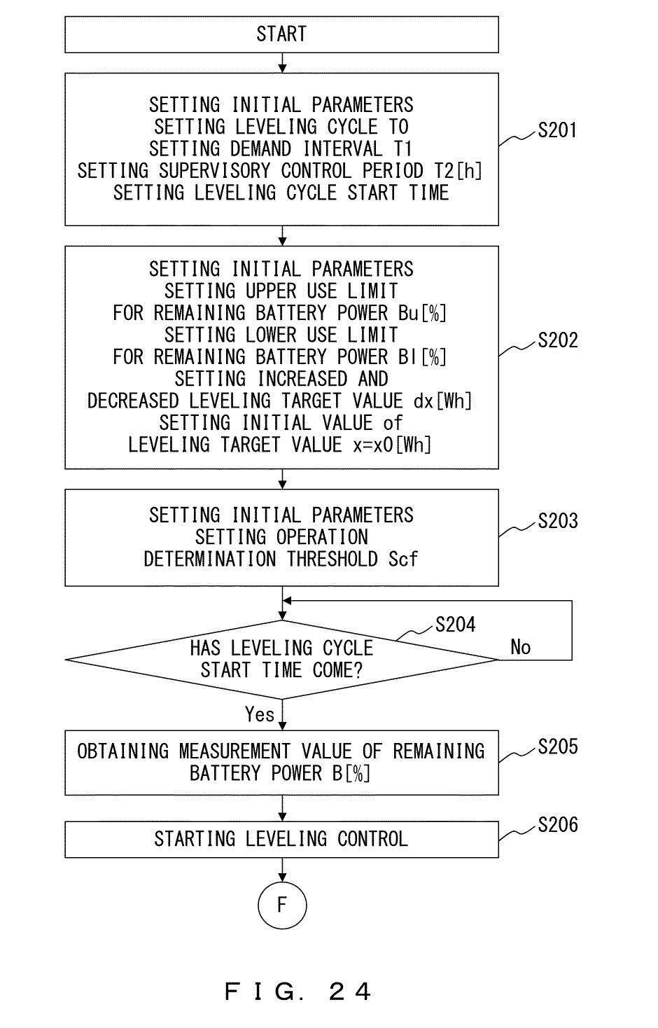

The operation of the power leveling system 50 according to the second embodiment will be described below with reference to FIGS. 24-27. FIGS. 24-27 are flowcharts depicting the operation of the power leveling system 50 according to the second embodiment. As illustrated in FIG. 24, the target determination unit 23 sets initial parameters of the power leveling control in advance (S201), in a similar manner to the operation performed by the power leveling system 1 according to the first embodiment. That is, the leveling cycle T0, the demand interval T1, the supervisory control period T2, and the leveling cycle start time are set and stored in the storage unit 24. Also, the upper use limit for remaining battery power Bu (%), the lower use limit for remaining battery power Bl (%), an increased and decreased leveling target value dx(Wh), and an initial value of leveling target value x=x0(Wh), which are used to control leveling target value determination, are set and stored in the storage unit 24 (S202). In the second embodiment, an operation determination threshold Scf is set and stored in the storage unit 24 (S203).

The target determination unit 23 monitors whether or not the leveling cycle start time set in S201 has come by comparing a time of the time obtaining unit (not illustrated) with the leveling cycle start time stored in the storage unit 24 (S204: “No”). When the leveling cycle start time has come (S204: “Yes”), the target determination unit 23 firstly obtains the remaining battery power B (%) as an initial value of the remaining battery power Br (S205), and starts performing leveling control (S206).

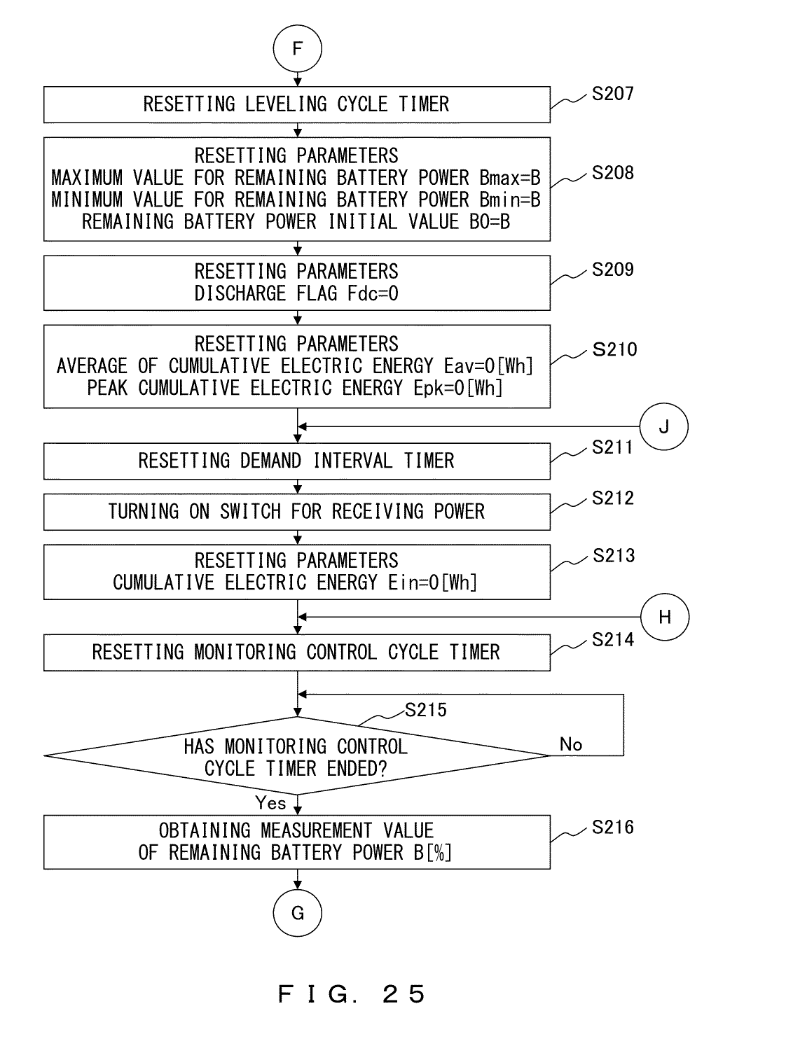

The process proceeds to that of FIG. 25, and the target determination unit 23 resets the leveling cycle timer (S207). Also, the target determination unit 23 resets the maximum value for remaining battery power Bmax, the minimum value for remaining battery power Bmin, and the remaining battery power initial value B0 such that Bmax=B (%), Bmin=B (%), and B0=B, respectively (S208). In the second embodiment, the target determination unit 23 resets the discharge flag Fdc such that Fdc=0 (S209), and the target determination unit 23 resets the average of cumulative electric energy Eav and the peak cumulative electric energy Epk such that Eav=0(Wh) and Epk=0(Wh) (S210). Further, the target determination unit 23 resets the demand interval timer (not illustrated) (S211).

The target determination unit 23 outputs an actuating signal to the switch controller 25 so as to close the switch 5 and start power reception, and the switch 5 is closed according to the instruction signal output from the switch controller 25 (S212). The target determination unit 23 resets the parameter to the cumulative electric energy Ein=0(Wh) (S213), and resets the monitoring control cycle timer (not illustrated) (S214). Moreover, the target determination unit 23 performs monitoring until the monitoring control cycle timer ends (S215: “No”). When the monitoring control cycle timer ends (S215: “Yes”), the target determination unit 23 obtains the remaining battery power Br measured by the remaining battery power level measurement unit 12 as “B” (S216).

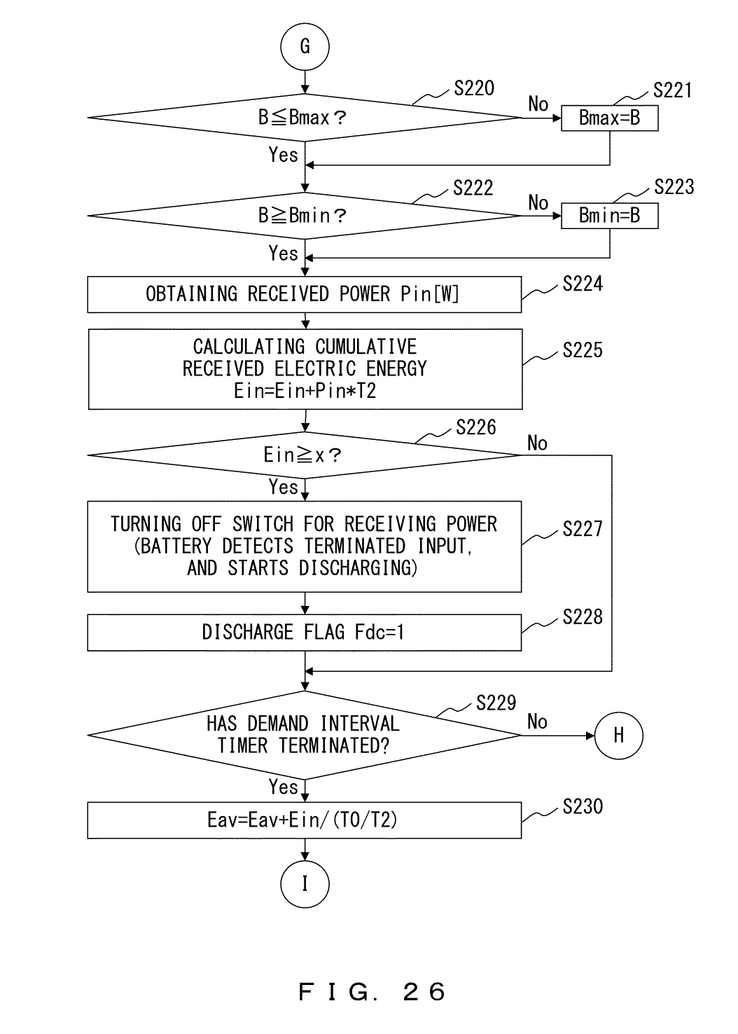

The processes proceed to those of FIG. 26, and the target determination unit 23 compares the obtained remaining battery power B with the maximum value for remaining battery power Bmax, and when the remaining battery power B is equal to or less than the maximum value for remaining battery power Bmax, the process proceeds to S222 (S220: “Yes”). When the remaining battery power B is greater than the maximum value for remaining battery power Bmax (S220: “No”), the maximum value for remaining battery power Bmax is updated to the remaining battery power B (S221), and the process proceeds to S222. The target determination unit 23 compares the obtained remaining battery power B with the minimum value for remaining battery power Bmin, and when the remaining battery power B is equal to or greater than the minimum value for remaining battery power Bmin, the process proceeds to S224 (S222: “Yes”). When the remaining battery power B is smaller than the minimum value for remaining battery power Bmin (S222: “No”), the minimum value for remaining battery power Bmin is updated to the remaining battery power B (S223), and the process proceeds to S224. The target determination unit 23 obtains the received power Pin (W) by using the received power measurement unit 9 (S224).

The target determination unit 23 calculates cumulative received electric energy “Ein=Ein+Pin*T2” (S224). The switch controller 25 compares the cumulative received electric energy Ein calculated in S224 with the current leveling target value x, and when the cumulative received electric energy Ein is less than the leveling target value x (S226: “No”), the process proceeds to S229. When the cumulative received electric energy Ein calculated in S225 is equal to or greater than the leveling target value x (S226: “Yes”), the switch controller 25 outputs an actuating signal to the switch 5 so as to cut off the connection, and the switch 5 cuts off the connection (S227) and makes the discharge flag “Fdc=1” (S228).

While the target determination unit 23 determines that the demand interval timer has not ended (S229: “No”), the processes of S214 of FIG. 25 through S229 of FIG. 26 are repeated. When it is determined that the demand interval timer has terminated (S229: “Yes”), the target determination unit 23 calculates the average of cumulative received electric energy “Eav=Eav+Ein/(T0/T2)” (S230).

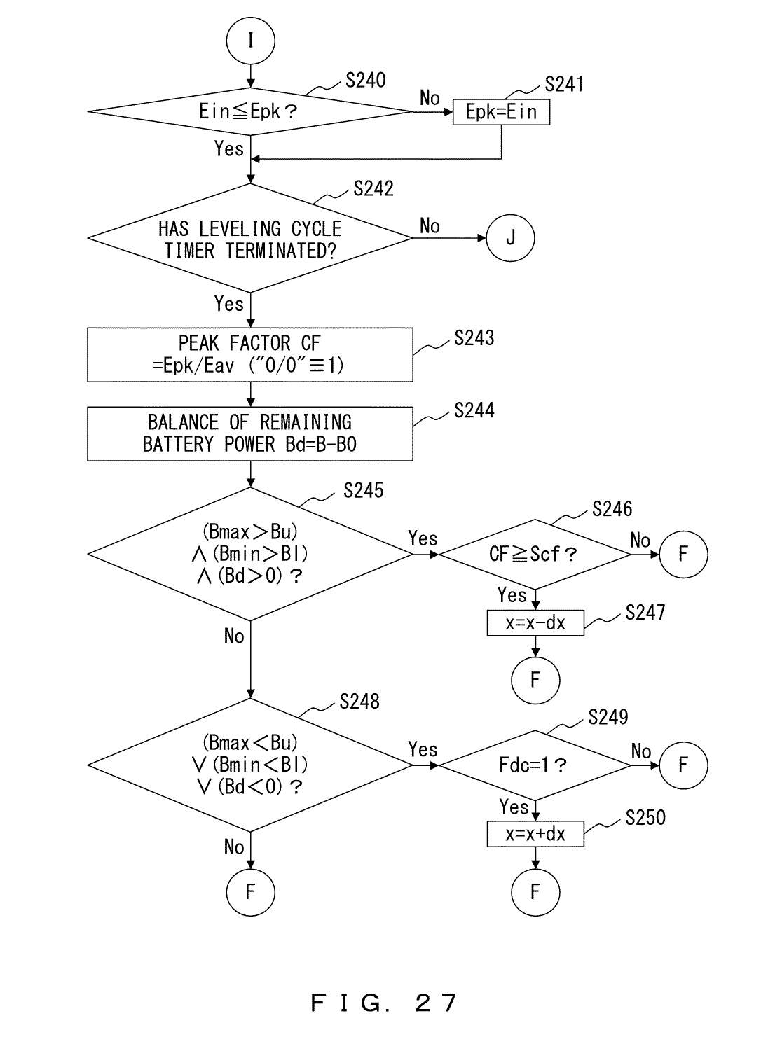

The process proceeds to that of FIG. 27, and the target determination unit 23 determines whether or not “cumulative received electric energy Ein≦peak of a cumulative amount of received electric energy Epk” holds true (S240). When the result of the determination does not meet the condition (S240: “No”), it is assumed that a peak of a cumulative amount of received electric energy Epk=Ein and the process proceeds to (S241) S242. When the condition is met, the process just proceeds to S242 (S240: “Yes”). Then, the target determination unit 23 determines whether or not the leveling cycle timer has terminated (S242). While the target determination unit 23 does not determine that the leveling cycle timer has not yet terminated (S242: “No”), the processes from S221 of FIG. 25 to S242 of FIG. 27 are repeated. When the target determination unit 23 determines that the leveling cycle timer has terminated (S242: “Yes”), “peak factor CF=Epk/Eav” is set. Here, “0/0” is defined to be “1” (S243). Moreover, the target determination unit 23 calculates a balance of the remaining battery power “Bd=B−B0” (S244), and proceeds the process to the determination process of the leveling target value x.

The target determination unit 23 determines whether the conditions “maximum value for remaining battery power Bmax>upper use limit for remaining battery power Bu”, “minimum value for remaining battery power Bmin>lower use limit for remaining battery power Bl”, and “charge and discharge balance Bd>0” are met (S245). When the compared values meet the conditions (S245: “Yes”), whether or not “peak factor CF operation determination threshold Scf” holds true is determined (S246). When the result of the determination meets the condition (S246: “Yes”), the leveling target value is updated to “x=x−dx” (S247), and the process returns to S207 of FIG. 25. When the compared value does not meet the condition, the process remains at S207. When it is determined in S245 that the compared values do not meet the conditions (S245: “No”), the process proceeds to S248.

The target determination unit 23 determines whether the conditions “maximum value for remaining battery power Bmax<upper use limit for remaining battery power Bu”, “minimum value for remaining battery power Bmin<lower use limit for remaining battery power Bl”, or “charge and discharge balance Bd<0” is met (S248). When the compared values meet at least one of the conditions (S248: “Yes”), the target determination unit 23 determines whether or not discharge flag Fdc=1 (S249). When the result of the determination meets the condition (S249: “Yes”), the leveling target value is updated to “x=x+dx” (S250), and the process returns to S207 of FIG. 25. When the result of the determination does not meet the condition, the process just returns to S207. When the compared values do not meet the conditions in S248 (S248: “No”), the process just returns to S207 of FIG. 25.

In the above processes, the target determination unit 23 performs a determination process or the like by storing the maximum value for remaining battery power Bmax, the minimum value for remaining battery power Bmin, the remaining battery power initial value B0, the discharge flag Fdc, the peak of a cumulative amount of received electric energy Epk, the average of cumulative received electric energy Eav, or the like in the storage unit 24, or by reading them from the storage unit 24.

As described above, in the power leveling control performed by the power leveling system 50 according to the second embodiment, the condition for increment determination and the condition for decrement determination in regard to the leveling target value x under specific conditions are added. In other words, the condition for increment determination used not to increase the leveling target value x when discharge is not performed in the leveling cycle T0, and the condition for decrement prevention used not to decrease the leveling target value x when the peak factor of the fluctuating load 13 is equal to or less than a threshold in the leveling cycle T0 are added.

Further, the power leveling system 50 may be configured such that the switch controller 25 detects a measurement value of the remaining battery power Br as indicated by an arrow 29, enabling determination to turn on forced charging for preventing load termination. When the switch controller 25 detects that the remaining battery power Br has become equal to or less than a certain value, load termination may be prevented by turning on the switch 5 in a forced manner.

As described above, according to the power leveling system 50 according to the second embodiment, in addition to the advantageous effects achieved by the power leveling system 1 according to the first embodiment, the following advantageous effects are achieved. That is, it becomes possible to lower the probability that the leveling control will fail to operate when there is no discharge in the leveling cycle T0 and the leveling target value x is increased in the next leveling cycle T0 on the basis of only the remaining battery power Br. Moreover, it becomes possible to lower the probability that the leveling target value x will be decreased on the basis of only the remaining battery power Br in the leveling cycle T0 where the fluctuating load 13 is not operating, and the probability that the leveling control is terminated due to the shortage of the remaining battery power Br when the fluctuating load 13 starts operating in the next leveling cycle T0. Accordingly, it becomes possible to prevent power leveling performance from deteriorating under specific conditions.

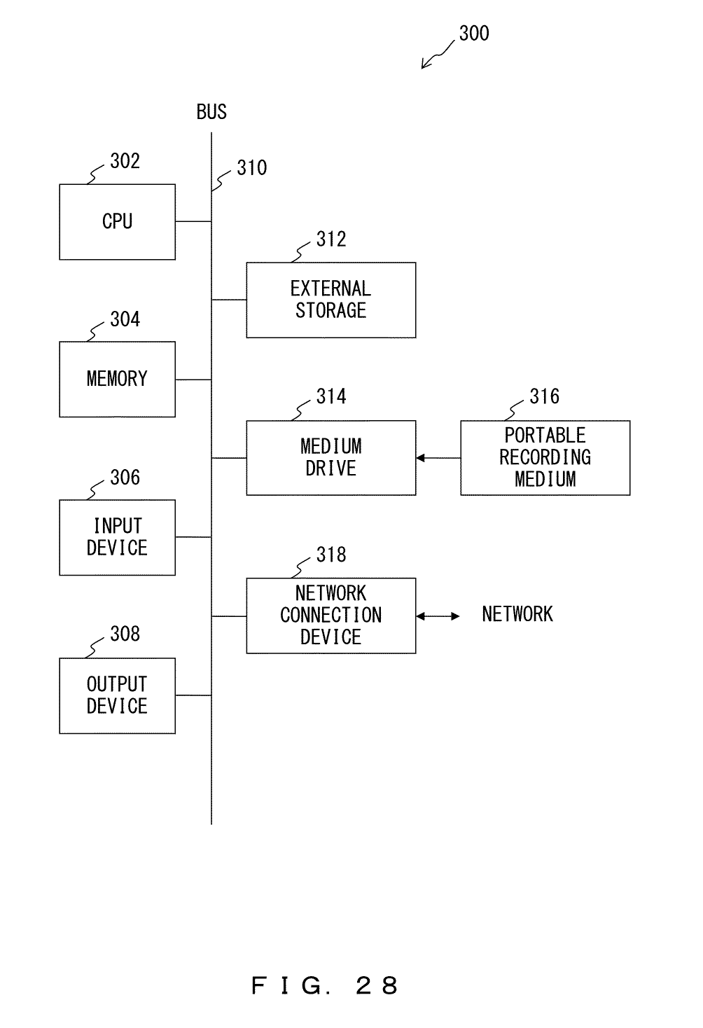

An example of the computer that is used in common to perform the leveling control according the first embodiment and its modification 1 and modification 2, and the second embodiment, as described above, by using a computer will be described below. FIG. 28 is a block diagram of an example of the hardware configuration of a standard computer. As illustrated in FIG. 28, a Central Processing Unit (CPU) 302, a memory 304, an input device 306, an output device 308, an external storage 312, a medium drive 314, a network connection device 318, or the like in a computer 300 are connected to each other via a bus 310.

The CPU 302 is a processor that controls the entire operation of the computer 300. The memory 304 is a storage unit in which a program for controlling the operation of the computer 300 is stored in advance, or a storage unit used as a working area as necessary when the program is executed. The memory 304 is, for example, a Random Access Memory (RAM), a Read Only Memory (ROM), or the like. When the input device 306 is manipulated by a user of the computer, the input device 306 obtains various kinds of information input by a user, which corresponds to the manipulation, and the input device 306 transmits the obtained input information to the CPU 302. The input device 306 is, for example, a keyboard device or a mouse device. The output device 308 is used to output the result of the processes performed by the computer 300. A display device or the like is included in the output device 308. The display device displays, for example, text or images according to the display data sent from the CPU 302.

The external storage 312 is, for example, a storage device such as a hard disk, and stores various kinds of control programs to be executed by the CPU 302, the obtained data, or the like. The medium drive 314 is used to perform writing and reading operations to/from a portable recording medium 316. The CPU 302 may be configured to perform various kinds of control processes by reading and executing a specified control program stored in the portable recording medium 316 via a recording medium drive 314. The portable recording medium 316 is, for example, a Compact Disc (CD) ROM, a Digital Versatile Disc (DVD), or a Universal Serial Bus (USB) memory. The network connection device 318 is an interface device that manages the transfer of various kinds of data with an external unit by cables or radio. The bus 310 is a communication path through which the above devices are connected to each other and data is transferred.

A program that causes the computer 300 to perform the leveling control according to the first embodiment and its modification 1 and modification 2, and the second embodiment as described above is stored, for example, in the external storage 312. The CPU 302 reads a program from the external storage 312, and performs power leveling control. In such power leveling control, a control program that causes the CPU 302 to perform the processes of leveling control is firstly created, and is stored in the external storage 312. Then, a specified instruction is given from the input device 306 to the CPU 302, and the control program is executed upon being read from the external storage 312. Note that the program may be stored in the portable recording medium 316.

In the above embodiment, for example, the process of S73 performed by the target determination unit 23 is an example of the operations to be performed by a received power obtaining unit according to the present invention. In a similar manner, the process of S68 is an example of the operations to be performed by a remaining battery power obtaining unit, the process of S100 is an example of the operations to be performed by a target determination unit, and the processes of S230 and S241 are examples of the operations to be performed by a calculation unit. The storage unit 24 is an example of the storage unit that stores a maximum value of the remaining battery power, the storage unit that stores a minimum value of the remaining battery power, the storage unit that stores an initial value of the battery power, the storage unit that stores a discharge flag, the storage unit that stores a peak of the cumulative amount of the received electric energy, and the storage unit that stores an average of the cumulative received electric energy. The demand interval T1 is an example of the unit of time according to the present invention.

According to the present invention, a power leveling controller, a power leveling storage battery, a method for controlling power leveling, and a leveling program that effectively utilizes the capacity of a storage battery, do not require demand forecasting, and enable power leveling with a simple process are provided.

For example, in the power leveling systems 1 and 50, the storage battery 7, the leveling controller 20, and the switch 5 are arranged as independent elements, but any combination of these elements, for example, a storage battery provided with the leveling controller 20 or the leveling controller 21, and the switch 5, are possible.

The increment determination and decrement determination of the leveling target value x that are described in the second embodiment may be combined with any of the first embodiment and its modification 1 and modification 2. Moreover, any possible combination, for example, the combination of the increment determination according to the modification 1 and the decrement determination according to the modification 2, is applicable. In the power leveling system 1, a system in which the received electric energy per unit of time is leveled out by power leveling control was described as an example, but leveling target value determination control may be applied in a similar manner to a system in which the received power is leveled out.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A power leveling controller that levels out power supplied from a power source in a system in which the power source is connected to a storage battery and a load, the power leveling controller comprising
a processor and a storage device, wherein
the processor
obtains an amount of remaining battery power of the storage battery for every monitoring period,
stores the obtained amount of remaining battery power in the storage device,
determines to increase, decrease, or maintain a current leveling target value for the leveling target value to be used in a next cycle for power leveling according to a value representing a transition of the amount of remaining battery power in a cycle in the stored amount of remaining battery power at an end of the cycle where a period in which demand for electricity of the load is high and a period in which demand for electricity of the load is low are predicted to occur in an alternating sequence, and
controls power that is supplied from the power source and the storage battery to the load according to the determined leveling target value to be used in the next cycle for power leveling.

2. The power leveling controller according to claim 1, wherein
when the leveling target value is determined, the processor determines to increase, decrease, or maintain the current leveling target value for the leveling target value to be used in a next cycle according to at least one of a maximum value, a minimum value, a last value, or a difference between an initial value and the last value of the amount of remaining battery power stored in the cycle.

3. The power leveling controller according to claim 2, wherein
when the leveling target value is determined, the processor increases the leveling target value to be used in a next cycle with reference to the current leveling target value when at least one of the maximum value falling below a first specified threshold, the minimum value falling below a second specified threshold, the last value falling below a third specified threshold, and the difference between the initial value and the last value falling below a fourth specified threshold is satisfied in the cycle.

4. The power leveling controller according to claim 2, wherein
when the leveling target value is determined, the processor decreases the leveling target value to be used in a next cycle with reference to the current leveling target value when at least one of the maximum value exceeding the first threshold, the minimum value exceeding the second threshold, the last value exceeding the third threshold, and the difference between the initial value and the last value exceeding the fourth threshold is satisfied in the cycle.

5. The power leveling controller according to claim 2, wherein
when the leveling target value is determined, the processor decreases the leveling target value to be used in a next cycle with reference to the current leveling target value when the maximum value falls below the first threshold in the cycle, when the minimum value falls below the second threshold in the cycle, or when the difference between the initial value and the last value falls below the fourth threshold in the cycle.

6. The power leveling controller according to claim 2, wherein
when the leveling target value is determined, the processor decreases the leveling target value to be used in a next cycle with reference to the current leveling target value when the maximum value exceeds the first threshold in the cycle, when the minimum value exceeds the second threshold in the cycle, and when the difference between the initial value and the last value has a positive value.

7. The power leveling controller according to claim 2, wherein
when the leveling target value is determined, the processor increases the leveling target value to be used in a next cycle with reference to the current leveling target value when the last value falls below the third threshold in the cycle and the difference between the initial value and the last value falls below the fourth threshold in the cycle, or when the minimum value falls below the second specified threshold in the cycle.

8. The power leveling controller according to claim 2, wherein
when the leveling target value is determined, the processor decreases the leveling target value to be used in a next cycle with reference to the current leveling target value when the maximum value exceeds the first threshold and the minimum value exceeds the second threshold in the cycle, and the difference between the initial value and the last value has a positive value or the last value exceeds the third threshold in the cycle.

9. The power leveling controller according to claim 2, wherein
the processor further stores a record of discharge in the storage device when the storage battery performs discharge, and
when the leveling target value is determined, the processor increases the leveling target value to be used in a next cycle with reference to the current leveling target value when the last value falls below the third threshold in the cycle and the difference between the initial value and the last value falls below the fourth threshold, or when the minimum value falls below the second threshold and the record of discharge stored in the storage device indicates an occurrence of discharge.

10. The power leveling controller according to claim 2, wherein
the power source is connected to the storage battery and the load through a switch unit in the system, and
the processor further
obtains cumulative electric energy obtained by accumulating received electric energy from the power source for every monitoring period for a specified unit of time, and
controls the switch unit so as to disconnect a connection between the power source, and the storage battery and the load when the cumulative electric energy exceeds the leveling target value, and so as to connect the power source with the storage battery and the load when the unit of time has elapsed.

11. The power leveling controller according to claim 2, wherein
the processor further
obtains received power from the power source, or cumulative received electric energy obtained by accumulating the received power from the power source for every monitoring period for a specified unit of time,
stores the obtained received power from the power source or cumulative electric energy accumulated for the unit of time in the storage unit,
calculates a ratio of a maximum value to an average value of received electric energy or received power in a specified cycle according to the stored cumulative received electric energy or the stored received power, and
decreases, when the leveling target value is determined, the leveling target value to be used in a next cycle with reference to the current leveling target value when the maximum value exceeds the first threshold, when the minimum value exceeds the second threshold in the cycle, when the difference between the initial value and the last value has a positive value or the last value exceeds the third threshold in the cycle, and further when the ratio exceeds a fifth specified threshold.

12. The power leveling controller according to claim 2, wherein
the processor further
obtains load power of the load, or cumulative load electric energy obtained by accumulating the load power for every monitoring period for a specified unit of time,
stores an amount of the obtained cumulative load electric energy accumulated for the unit of time or the load power in the storage device,
calculates a ratio of a maximum value to an average value of load electric energy or load power in a specified cycle according to the stored cumulative load electric energy or the stored load power, and
decreases, when the leveling target value is determined, the leveling target value to be used in a next cycle with reference to the current leveling target value when the maximum value exceeds the first threshold, when the minimum value exceeds the second threshold in the cycle, when the difference between the initial value and the last value has a positive value or the last value exceeds the third threshold in the cycle, and further when the ratio exceeds a fifth specified threshold.

13. The power leveling controller according to claim 1, wherein
the processor further
stores a record of discharge in the storage device when the storage battery performs discharge, and
determines, when the leveling target value is determined, to increase, decrease, or maintain the current leveling target value for the leveling target value to be used in a next cycle according to the record of discharge stored in the storage device at an end of the cycle.

14. The power leveling controller according to claim 2, wherein
received power from the power source, or cumulative received electric energy obtained by accumulating the received power from the power source for every monitoring period for a specified unit of time is obtained,
the obtained received power or cumulative electric energy accumulated for the unit of time is stored in the storage unit,
a maximum value and an average value in the cycle are calculated according to the stored received power or the stored cumulative received electric energy, and
when the leveling target value is determined, a current value is determined to be increased, decreased, or maintained for the leveling target value to be used in a next cycle according to the maximum value and the average value at an end of the cycle.

15. A method for controlling power leveling, where power supplied from the power source is leveled out in a system in which a power source is connected to a storage battery and a load, the method comprising:
obtaining, by using a processor, an amount of remaining battery power of the storage battery for every monitoring period;
storing, by using a processor, the obtained amount of remaining battery power in a storage device;
determining, by using a processor, to increase, decrease, or maintain a current leveling target value for the leveling target value to be used in a next cycle for power leveling according to a value representing a transition of the amount of remaining battery power in a cycle in the amount of remaining battery power stored in the storing of the obtained amount of remaining battery power at an end of the cycle where a period in which demand for electricity of the load is high and a period in which demand for electricity of the load is low are predicted to occur in an alternating sequence, and
controlling, by using a processor, power that is supplied from the power source and the storage battery to the load according to the determined leveling target value to be used in the next cycle for power leveling.

16. A computer-readable recording medium having stored therein a program for causing a computer to execute, in a system where a power source is connected to a storage battery and a load, a process of power leveling control for leveling out power supplied from the power source, the process comprising:
obtaining an amount of remaining battery power of the storage battery for every monitoring period;
storing the obtained amount of remaining battery power in a storage device;
determining to increase, decrease, or maintain a current leveling target value for the leveling target value to be used in a next cycle for power leveling according to a value representing a transition of the amount of remaining battery power in a cycle in the stored amount of remaining battery power at an end of the cycle where a period in which demand for electricity of the load is high and a period in which demand for electricity of the load is low are predicted to occur in an alternating sequence; and
controlling power that is supplied from the power source and the storage battery to the load according to the determined leveling target value to be used in the next cycle for power leveling.
